(19) United States
(12) Patent Application Publication
(10) Pub. No.: US 2024/0088358 A1
(43) Pub. Date: Mar. 14, 2024

(54) ELECTRODE FOR LITHIUM SECONDARY BATTERY HAVING ENCAPSULATED ACTIVE MATERIAL AND METHOD OF MANUFACTURING THE SAME

(71) Applicants: VITZROCELL CO. LTD., Dangjin-si, Chungcheongnam-do (KR); MAKESENS INC., Calgary, Alberta (CA)

(72) Inventors: Simon PARK, Calgary, Alberta (CA); Chaneel PARK, Calgary, Alberta (CA); Hongseok CHO, Calgary, Alberta (CA); Jong-Song KIM, Dangjin-si, Chungcheongnam-do (KR); Kyoung-Soo PARK, Dangjin-si, Chungcheongnam-do (KR); Ji-Hoon KANG, Dangjin-si, Chungcheongnam-do (KR)

(21) Appl. No.: 18/282,286

(22) PCT Filed: Jan. 28, 2022
(86) PCT No.: PCT/KR2022/001633

§ 371 Date: Sep. 15, 2023

Related U.S. Application Data
(60) Provisional application No. 63/161,434, filed on Mar. 15, 2021.

(30) Foreign Application Priority Data
Nov. 24, 2021 (KR) 10-2021-0163813

(51) Int. Cl. H01M 4/36; H01M 4/04; H01M 4/38; H01M 4/62

(52) U.S. Cl. CPC H01M 4/366; H01M 4/0404; H01M 4/0459; H01M 4/0471; H01M 4/386; H01M 4/622; H01M 4/625

(57) ABSTRACT

The present disclosure relates to a method for manufacturing an electrode for a lithium secondary battery having encapsulated active material using energy application, and the method helps to minimize the volume change of an electrode or negative side effects, such as high internal stress, a fracture, pulverization, delamination, electronic isolation from a conductive agent, the formation of an unstable solid-electrolyte interphase, and a loss of energy capacity of the batteries.

### TECHNICAL FIELD

Disclosed herein is a lithium secondary battery such as a lithium-ion battery, a lithium-metal battery, a lithium-sulfur battery, a lithium-air battery and the like, and in particular, disclosed herein are an electrode for a lithium secondary battery having encapsulated active materials, and a method of manufacturing the same that ensures improvement in the performance and reliability of a lithium secondary battery.

### BACKGROUND ART

There is a growing demand for lithium secondary batteries such as lithium-ion batteries, as the batteries are applied to a wide range of products from small and portable electronic devices to large electric vehicles. In addition, a visible change from fossil fuel-run vehicles to electric vehicles has taken place. Under the circumstances, lithium secondary batteries showing high performance attracts great public attention. Thus, research has been performed into technologies for developing a lithium-ion battery that ensures higher capacity, a longer lifespan, rapid charging, and assured safety. One of the technologies involves developing an electrode to which active materials having high energy density are applied.

Silicon (Si; theoretical specific capacity of 3,600 mAh/g) is a rising active material for anodes of lithium-based batteries because of its high energy density. Additionally, sulfur (S; theoretical specific capacity of 1,675 mAh/g) is considered an active material for cathodes of lithium-based batteries, due to their high energy density. However, silicon and sulfur are also known for high volume expansion rates during repeated lithiation processes. Such a rapid volume change leads to the pulverization and delamination of the active materials, thereby causing a lack of electrode integrity and electrical isolation, and deterioration in the performance of the batteries.

As means to solve the problems associated with the volume expansion rate of these active materials, several ideas have been proposed and tested. As shown in the following list of other intellectual properties or academic references, some involve reducing the particles sizes of active materials to prevent pulverization. Others involve encapsulating active materials with a hard outer shell to suppress volume change or provide enough space for an individual active material, so that the active material can expand and shrink without applying stress to the other active materials.

Also, still others involve creating nano-porous structures on active materials or their coatings, to increase a contact surface area for easier ion diffusion. However, the techniques incur large amounts of economic or environmental costs in terms of their procedures, resulting in an increase in the cost of a battery product.

Secondary Battery and Production Method for Secondary Battery and Production Device for Secondary Battery, US 2004/0107564 A1

The document relates to a manufacturing method of a secondary battery, comprising a mechanism for feeding an anode sheet-like material and a cathode sheet-like material. A first feeding device includes a drive roller which is rotatable by a motor. The feeding device is attached to a common apparatus frame or a separate frame through a bearing. A nip roller is pressed by a pressing device such as a cylinder, a spring or a screw shaft with a predetermined force upon the device roller. The first feeding system feeds a positive electrode sheet towards a first coating system. A second feeding device is constructed in a similar way to the first feeding device. It feeds a negative electrode sheet towards a second coating system.

Carbon Nanotube Polymer Lithium-Ion Battery and Preparation Method Thereof, CN 2016/105 720 265 A

The document relates to a positive electrode made from cobalt acid lithium and nickel cobalt lithium manganate with the cladding of carbon nanotube polymer. A process by which a battery is prepared is also described. The battery is described as having increased gram capacity, energy density, increased residual capacity after repeated charging/discharging, and a longer cycle lifetime.

Hybrid Nano-Filament Anode Compositions for Lithium-Ion Batteries, Global Graphene Group Inc., US 2017/9564629 B2

The document relates to a composition for a hybrid nano-filament electrochemical cell electrode. The composition consists of an aggregate of nanometer-sized electrically conductive filaments made of materials such as carbon nanotubes (CNTs) and carbon nanofibers (CNFs) that are interconnected and form a network of interconnected pores. The filaments are coated on a micro/nano-sized surface consisting of an anode active material capable of the absorption and desorption of lithium-ions which can be made from a variety of materials including silicon, alloys of silicon, and oxides of silicon.

Compositions including nano-particles and a nano-structured support matrix and methods of preparation as reversible high capacity anodes in energy storage systems, University of Pittsburgh, US 2020/10 878 977 B2

The document relates to a composition in relation to a lithium-ion battery anode electrode and its preparation method in which a vertically aligned nanostructured support matrix is created consisting of nanostructures such as CNTs. Interfacial bonding between this nanostructured support matrix and nanoparticles forms an electrode with improved properties for use in lithium-ion batteries. The support matrix can also be grown onto a substrate consisting of a current collector material.

Electrode and method with nanostructures made of porous silicon, JP 2017/518 621 A

The document relates to a silicon-based microstructure material used as an electrode for a battery. The invention consists of porous silicon spheres which are mixed with CNTs. The porous silicon spheres are synthesized through a hydrolysis process with surface protected magnesium thermal reduction. CNTs were added to the porous silicon spheres through mixing, thus creating a battery electrode with a better charge transfer and minimizing the degradation of electronic contact between silicon and an additive or a binder.

Nanotube composite anode materials suitable for lithium-ion battery applications, UChicago Argonne, LLC, US 2011/0104551 A1

The document relates to an anode material used for lithium-ion batteries which consists of a carbon nanotube composite material. The material consists of aligned carbon nanotubes with a lithium-alloying material on the internal or external surface of tubes. A typical lithium alloying material is silicon. The combination of silicon and the aligned carbon nanotubes allows of quicker charge/discharge rates, higher capacities, and greater stability during cycling. This is attributed to the elastic deformability of CNTs which compensate for large volume expansions and prevent delamination.

Preparation method for negative electrode material of lithium-ion battery, WO 2015/124 049 A1

The document relates to the creation of a negative electrode material for lithium-ion batteries. Carbon nanotubes are dispersed in a solution and put through several processing steps of sintering and drying to form a composite material consisting of CNTs, silicon, and carbon. Silicon is sandwiched between a carbon nanotube network and an outer carbon shell, which acts as a buffer layer to prevent expansion. Furthermore, the conductivity of silicon is increased through the CNT network and an outer covering of carbon.

A silicon-carbon negative electrode active material and preparation method thereof, silicon-carbon negative electrode material and lithium-ion battery, CN 2020/110 697 685 A

The document relates to a composite material for the creation of a negative electrode for use in lithium-ion batteries. The composite material consists of silicon particles mixed with metal particles and a form of carbon material. The silicon-carbon material is coated with a conductive network of carbon nanotubes. Their preparation method results in the production of silicon particles uniformly coated with a point-line combined conductive network of a one-dimensional linear carbon nanotube composite with metal particles. This improves the conductivity of silicon and increases cycling stability and rate capability.

Anode active material for secondary battery and preparation method for thereof, LG Energy Solution, KR 2015/68 458 B1

Physical damage in silicon due to repeated charge and discharge cycles has been recognized as a challenge in LIB. Double-walled CNTs (DWCNT) can be used as a protective layer of silicon particles, in order to minimize physical damages caused by expansion. Anode active materials in the document include CNTs with multiple silicon particles inserted into a nanotube. The top and bottom of the nanotube are open, in order for silicon particles to freely enter the structure. Since the outer wall of DWCNTs configures a hexagonal structure, it undergoes a radial breathing vibration. Hence, the inner volume of the CNTs can freely change to fit the silicon particles. The maximum weight percentage of silicon in a single DWCNT is 80 wt. %; if this threshold is exceeded, the effect of lithium-ion adhesion decreases, as well as being difficult to retain inner space of CNTs due to the expansion of silicon during charge and discharge. If the silicon composition is less than 20 wt. %, then electrical conductivity decreases. Lastly, the silicon particles must range between 50-200 nm in radius, in order to ensure the particles to stay in place within the nanotubes and leaving enough free space within the nanotube during charge and discharge. A CNT sheet is loaded in an ultra-high vacuum (UHV) chamber of under 10⁻⁶ Torr; high-purity silicon particles (99.98% or more) is inserted in its vapor phase. Through van der Waals and capillary forces, silicon vapor enters the nanotubes. Lastly, a chamber temperature is set to 600° C. under UHV for 8-24 hours for a cooling process. The silicon vapor forms nanoparticles of 50-200 nm in radius during the cooling.

Large-volume-change lithium battery electrodes, US 2015/0099187A1

The document relates to a pomegranate-inspired hierarchical structure with electrically interconnected primary Si nanoparticles and an individually engineered nanoscale empty space encapsulated by a carbon layer to form micrometer-sized secondary particles. Internally accommodated volume expansion and spatially confined SEI formation results in a superior cycle life (e.g., 1000 cycles with at least about 97% capacity retention), while the secondary structure lowers an electrode/electrolyte contact area for the improvement in CE and increases tap density. Furthermore, unprecedented stable cycling (e.g., 100 cycles with at least about 94% capacity retention) with high areal capacity (e.g., at least about 3.7 mAh/cm 2) is demonstrated, similar to the areal capacity of commercial Li-ion batteries. The design principles developed in the document can be widely applied to other high-capacity Li battery electrodes such as germanium (Ge), tin (Sn), tin oxide (SnO), siliconoxide (SiO), phosphorus (P) and sulfur (S). Furthermore, an electroless plating method is developed for a substantially uniform copper coating on Si pomegranate structures. The presence of a coated copper layer significantly enhances inter-particle electrical conductivity in an electrode. As a result, the copper-coated structure exhibits excellent electrochemical performance, including stable cycling performance at a high mass loading (e.g., an areal capacity of at least about 3.13 mAh/cm 2 at a mass loading of at least about 4.10 mg/cm 2 after 100 cycles), and excellent rate capability (e.g., at least about 86.1 mAhg⁻¹ at 1C rate and at least about 467 mAhg⁻¹ at 4C rate).

Carbon-silicon composite and manufacturing method thereof, U.S. Ser. No. 10/193,148B2

The document relates to a manufacturing method of a carbon-silicon composite, including: (a) preparing a silicon-carbon-polymer matrix slurry including a silicon slurry, carbon particles, a monomer of polymer, and a cross-linking agent; (b) performing a heat treatment process on the silicon-carbon-polymer matrix slurry to manufacture a silicon-carbon-polymer carbonized matrix; (c) pulverizing the silicon-carbon-polymer carbonized matrix structure; and (d) mixing the silicon-carbon-polymer carbonized matrix structure with a first carbon raw material and performing a carbonization process to manufacture a carbon-silicon composite. The invention is similar to the proposed embodiments as heat is used to carbonize polymers and a silicon-carbon-polymer matrix is created. The method of carbonization, however, is limited to a thermal heating process.

Si/C composite material, method for manufacturing the same, and electrode, US 2014/0234722A1

The document relates to a composite material in which Si and carbon are combined so as to form an unprecedented structure; a method for fabricating the same; and a negative electrode material for lithium-ion batteries ensuring high charge discharge capacity and high cycle performance. The novelty in the document is the use of a source gas containing carbon while heating Si nanoparticles, inducing a carbon layer formation on Si nanoparticles.

Encapsulated anode active material particles, lithium secondary batteries containing same, and method of manufacturing, WO 2018/186963A1

The document relates to a particulate of an anode active material for a lithium battery, comprising one or a plurality of anode active material particles being embraced or encapsulated by a thin layer of a high-elasticity polymer. According to the document, the high-elasticity polymer has a recoverable tensile strain no less than 5%, and a lithium ion conductivity no less than 10⁻⁶ S/cm at room temperature.

Encapsulated cathode active material particles, lithium secondary batteries containing same, and method of manufacturing, WO 2018/191026A1

The document relates to a particulate of a cathode active material for a lithium battery, comprising one or a plurality of cathode active material particles being embraced or encapsulated by a thin layer of a high-elasticity polymer.

### PRIOR ART DOCUMENT

### Patent Documents

(Document 001) US 2004/0107564 A1 (2004.06.10)
(Document 002) CN 105720265 A (2016.06.29)
(Document 003) U.S. Pat. No. 9,564,629 B2 (2017.02.07)
(Document 004) U.S. Pat. No. 10,878,977 B2 (2020.12.29)
(Document 005) JP 2017/518621 A (2017.07.16)
(Document 006) US 2011/0104551 A1 (2011.05.05)
(Document 007) WO 2015/124049 A1 (2015.08.27)
(Document 008) CN 110697685 A (2020.01.17)
(Document 009) KR10-1568458 B1 (2015.11.05)
(Document 010) US 2015/0099187 A1 (2015.04.09)
(Document 011) U.S. Pat. No. 10,193,148 B2 (2019.01.29)
(Document 012) US 2014/0234722 A1 (2014.08.21)
(Document 013) WO 2018/186963 A1 (2018.10.11)
(Document 014) WO 2018/191026 A1 (2018.10.18)
(Document 015) US 2010-0035152 A1 (2010.02.11)

### Non-Patent Documents

(Document 001) Li, L., Yang, H., Zhou, D., & Zhou, Y. (2014). Progress in Application of CNTs in Lithium-Ion Batteries. Journal of Nanomaterials, 2014, 1-8. https://doi.org/10.1155/2014/187891
(Document 002) Tagawa*, K., & Brodd, R. J. (2008). Production Processes for Fabrication of Lithium-Ion Batteries. Lithium-Ion Batteries, 1-14. https://doi.org/10.1007/978-0-387-34445-4_8
(Document 003) B. J. Landi, M. J. Ganter, C. D. Cress, R. A. DiLeo, and R. P. Raffaelle, “Carbon nanotubes for lithium-ion batteries,” Energy & Environmental Science, vol. 2, no. 6, p. 638, April 2009. L. Xue, G. Xu, Y. Li, S. Li, K. Fu, Q. Shi, and X. Zhang, “Carbon-Coated Si Nanoparticles Dispersed in Carbon Nanotube Networks As Anode Material for Lithium-Ion Batteries,” ACS Applied Materials & amp; Interfaces, vol. 5, no. 1, pp. 21-25, 2012.
(Document 004) B. J. Landi, M. J. Ganter, C. D. Cress, R. A. DiLeo, and R. P. Raffaelle, “Carbon nanotubes for lithium-ion batteries,” Energy & Environmental Science, vol. 2, no. 6, p. 638, April 2009.
(Document 005) Song, D. P., Li, W., Park, J., Fei, H. F., Naik, A. R., Li, S., Zhou, Y., Gai, Y., & Watkins, J. J. (2021). Millisecond photothermal carbonization for in-situ fabrication of mesoporous graphitic carbon nanocomposite electrode films. Carbon, 174, 439-444. https://doi.org/10.1016/j.carbon.2020.12.036
(Document 006) Song, D. P., Naik, A., Li, S., Ribbe, A., & Watkins, J. J. (2016). Rapid, Large-Area Synthesis of Hierarchical Nano-porous Silica Hybrid Films on Flexible Substrates. Journal of the American Chemical Society, 138(41), 13473-13476. https://doi.org/10.1021/jacs.6b06947
(Document 007) Bhandavat, R., & Singh, G. (2013). Stable and Efficient Li-Ion Battery Anodes Prepared from Polymer-Derived Silicon Oxycarbide-Carbon Nanotube Shell/Core Composites. The Journal of Physical Chemistry C, 117(23), 11899-11905. https://doi.org/10.1021/jp310733b
(Document 008) Colombo, P., Mera, G., Riedel, R., & Soraru, G. D. (2010). Polymer-Derived Ceramics: 40 Years of Research and Innovation in Advanced Ceramics. Journal of the American Ceramic Society, no. https://doi.org/10.1111/j.1551-2916.2010.03876.x
(Document 009) S. Choi, D. S. Jung, J. W. Choi Scalable fracture-free SiOC glass coating for robust silicon nanoparticle anodes in lithium secondary batteries Nano Lett., 14 (2014), pp. 7120-7125
(Document 010) Muhammad Idrees, Saima Batool, Qiang Zhuang, Jie Kong, Ilwoo Seok, Jiaoxia Zhang, Hu Liu, Vignesh Murugadoss, Qiang Gao, Zhanhu Guo, Achieving carbon-rich silicon-containing ceramic anode for advanced lithium-ion battery, Ceramics International, Volume 45, Issue 8, 2019, Pages 10572-10580.
(Document 011) V. Liebau-Kunzmann, C. Fasel, R. Kolb, R. Riedel Lithium containing silazanes as precursors for SiCN: Li ceramics-a potential material for electrochemical applications J. Eur. Ceram. Soc., 26 (2006), pp. 3897-3901
(Document 012) M. Graczyk-Zajac, G. Mera, J. Kaspar, R. Riedel Electrochemical studies of carbon-rich polymer-derived SiCN ceramics as anode materials for lithium-ion batteries J. Eur. Ceram. Soc., 30 (30) (2010), pp. 3235-3243
(Document 013) J. Kaspar, M. Graczyk-Zajac, R. Riedel Lithium insertion into carbon-rich SiOC ceramics: influence of pyrolysis temperature on electrochemical properties J. Power Sour., 244 (2013), pp. 450-455
(Document 014) D. Su, Y. L. Li, Y. Feng, J. Jin Electrochemical properties of polymer-derived SiCN materials as the anode in lithium-ion batteries J. Am. Ceram. Soc., 92 (2009), pp. 2962-2968
(Document 015) H. Fukui, K. Eguchi, H. Ohsuka, T. Hino, K. Kanamura, Structures and lithium storage performance of Si—O—C composite materials depending on pyrolysis temperatures J. Power Sour., 243 (2013), pp. 152-158
(Document 016) Byoung-Sun Lee, Jihyun Yoon, Changhoon Jung, Dong Young Kim, Seung-Yeol Jeon, Ki-Hong Kim, Jun-Ho Park, Hosang Park, Kang Hee Lee, Yoon-Sok Kang, Jin-Hwan Park, Heechul Jung, Woong-Ryeol Yu, and Seok-Gwang Doo, Silicon/Carbon Nanotube/BaTiO3 Nanocomposite Anode: Evidence for Enhanced Lithium-Ion Mobility Induced by the Local Piezoelectric Potential, ACS Nano 2016 10 (2), 2617-2627
(Document 017) S. Satapathy, P. K. Gupta, S. Pawar, and K. B. R. Varma, “Crystallization of Beta-phase Poly (vinylidene fluoride) films using dimethyl sulfoxide (DMSO) solvent and at suitable annealing condition,” arXiv:0808.0419 [cond-mat], August 2008.
(Document 018) K. R. May, The collison nebulizer: description, performance and application, J. Aerosol Sci., 4 (1973), pp. 239-243

### DISCLOSURE

### Technical Problem

The present disclosure relates to a lithium secondary battery such as a lithium-ion battery, a lithium-metal battery, a lithium-sulfur battery, a lithium-air battery and the like. The lithium secondary battery includes an anode, a cathode, an electrolyte, and a separator. The anode and the cathode respectively include a current collector and active materials.

The present disclosure is directed to a novel method of encapsulating active materials, thereby providing a multi-layered structure with hard protective shell, space for volume expansion and a nano-porous structure for ion diffusion. The manufacturing process used for this method is energy and time-efficient, while minimizing initial installation cost.

The manufacturing process according to the present disclosure is implemented as a roll-to-roll (R2R) manufacturing process in which some additions are made to a conventional R2R manufacturing process, essentially keeping the process with the same efficiency as the conventional R2R manufacturing process.

### Technical Solution

The objective of the present disclosure is to provide an encapsulation method for active materials with large volume expansion ratios such as silicon or sulfur. In the method, active materials are mixed with one or more polymer binders such that the active materials are encapsulated within polymers, and then an outer shell of the active materials are carbonized via the application of energy such as electromagnetic irradiation.

In the present disclosure, the technique for applying energy may include the radiation of electromagnetic waves such as a laser, microwaves, or intense pulsed light (IPL), or a Joule heating process to partially carbonize polymeric binder materials.

The polymer binders contain the 1D or 2D types of carbon-based materials such as carbon nanotubes and/or graphene oxides to enhance the absorption of energy from electromagnetic waves in a wide range of wavelengths, and to enhance the electrical conductivity of a resulting structure.

The polymeric binder materials are used in combination of two binders with distinguishable boiling points, or formed of double network (DN) hydrogels, so the energy intensive carbonization process evaporates materials with a low boiling point along with a solvent, leaving nano-porous structures. The nano-porous structure allows of the diffusion of lithium-ions into core active materials.

Among various energy application methods, the IPL process relies on the spontaneous irradiation of highly powered xenon-light in a few milliseconds, and thus, the carbonization effect is focused mainly on the surface of the outer shell, resulting in a multi-layer structure of a hard carbonized outer layer and an inner soft polymer layer.

The carbonized outer shell provides electrical conductivity along a solid electrolyte interphase (SEI) and structural support. The inner layer of the soft polymer is elastic, and provides an active material space for volume expansion without high mechanical stress.

The binder materials can also be an organosilicon polymer (i.e. polysiloxane and polycarbosiloxane) and/or a sulfur-containing polymer (i.e. polysulfoxide and poly (sulfur nitride)) containing active elements within them. The active elements within the polymeric binders provide additional energy capacity for an electrode.

The binder materials can also be a piezoelectric polymer such as polyvinyl difluoride (PVDF). Piezoelectric binder materials transfer internal stress from volume expansion of active materials into piezoelectric charges, further accelerating an electrical charging process.

The encapsulation and energy application processes can be performed in preparation of active materials in a powder form, or after deposition on a current collector in a slurry form. The powder generation of the encapsulated active materials could be performed using a nebulizer or an electro-spraying process, creating particles having a size of hundreds of nanometers. The irradiation of energy in powder form could lead to the formation of the encapsulated active materials as described above. Another method is to use a slurry mixture, deposited on the current collector using a film coater and calendared to create a thin film of the electrode. The irradiation of energy to the thin film could lead to the formation of the encapsulated active materials as described above.

Yet another method is to use an electro-spinning method to form the electrode. The polymeric binders could form fibers, encapsulating active materials within the fibers. The carbonization of the spun-out fibers further enhances their mechanical strength, electrical conductivities and crate nano-porous structures. A fiber mat fabricated through electro-spinning does not require an additional process of deposition; it can be placed on top of the current collector as an electrode layer as it is.

Specifically, according to the present disclosure, a method for a lithium secondary battery, which helps to minimize the volume change of anodes and cathodes of a lithium secondary battery such as a lithium-ion battery, a lithium-metal battery, a lithium-air battery, a lithium-sulfur battery, a lithium solid-state battery and the like, or negative side effects, such as high internal stress, a fracture, pulverization, delamination, electronic isolation from a conductive agent, the formation of an unstable solid-electrolyte interphase, and a loss of energy capacity of the battery.

A composition used for the method of manufacturing an electrode for a lithium secondary battery, according to the disclosure, includes active materials, polymeric binders, carbon-based additives, and a solvent. The composition includes 80-95 parts by weight of active materials, 1-10 parts by weight of conductive carbon-based additives, 3-10 parts by weight of polymeric binders, with respect to 100 parts by weight of the solid content, except for the solvent. The content of the active materials, the conductive carbon-based additives, and the polymeric binders may vary depending on the sort of materials used. Additionally, 50-90 parts by weight of the solvent can be used with respect to 100 parts by weight of the solid content, depending on the sort of polymeric binders used. The mentioned content of the materials is preferable to ensure the uniform dispersion of the materials, smooth deposition and a proper thickness of an active material capsule, but not limited.

In this disclosure, one method of encapsulating the active materials is the fabrication of encapsulated powder, and the fabrication of a slurry-based encapsulated electrode, and the carbonization and nanopore generation of encapsulated layers via the application of energy.

The electrode active material according to the disclosure has high energy capacity and a large volume change during a lithiation process. Anode materials may consist of, but not be limited to, silicon, silicon oxide, silicon carbide, magnesium silicide, silicon-iron-manganese alloys, manganese silicate, various sorts of silicon alloys, aluminum, tin, and pre-lithiated alloys of LiₓSi—Li₂O core-shell nanoparticles, and a mixture of them, and conventional intercalating anode materials of graphite at varying ratios. Cathode materials may consist of, but not be limited to, sulfur.

The polymeric binder materials for encapsulating active materials according to the disclosure include mixtures of two or more polymers and copolymers having different boiling points. The mixture of the polymers may include, but not be limited to, two or more of polyacrylonitrile (PAN), polytetrafluoroethylene (PTFE), poly(methyl methacrylate; PMMA), poly(3,4-ethylenedioxythiophene) polystyrene sulfonate (PEDOT:PSS), polydiacetylenes (PDA), polypropylene (PP), polystyrene (PS), polyurethane (PU), polyethylene oxide (PEO), polyethylene terephthalate (PET), Styrene-ethylene-butylene-styrene (SEBS), glycerol, asphaltene, meso-phase pitch, sucrose, cellulose, and lignin.

The polymeric binder materials for encapsulating active materials according to the disclosure are formed of double network (DN) hydrogels consisting of conventional covalently crosslinking polymers and another network with renewable bonding. The DN hydrogels may include combinations of carboxylmethyl cellulose (CMC) and polyacrylic acid (PAA), polyacrylic acid (PAA) and polyethylene glycol (PEG), polyacrylic acid (PAA) and polyethylenimine (PEI), polyacrylic acid (PAA) and chitosan, a styrene/butadiene copolymer (SBR) and polymethyl methacrylate (PMMA) and more.

The polymeric binder materials according to the disclosure may contain polymers with elements of active materials, including organosilicon materials such as polysiloxane, polysilsesquioxane, polycarbosiloxane, polyborosiloxane and polysilicarbodiimide and sulfur-containing polymers such as polysulfoxide and poly (sulfur nitride), which provide additional electrical charges. Some of the polymers with elements of active materials can be carbonized via the application of energy and form an outer shell. In this case, the outer shell may include SiOC (silicon oxycarbide), SiC (silicon carbide), SiBCN (silicoboron carbonitride), SiCN (silicon carbonitride), SC (a sulfur-carbon composite), or SCN (thiocyanate), and the like. Additionally, if the active materials include magnesium, zinc, titanium, iron and the like, polymers including magnesium, zinc, titanium, iron and the like can be used as binder materials, and some of the binder materials can be carbonized via the application of energy.

The polymeric binder materials according to the disclosure consist of polymers with piezo-electric properties, which provide additional electrical charges due to internal stress resulting from the volume increase of active materials during the lithiation cycle. The polymers with piezo-electric properties consist of, but are not limited to, semicrystalline polymers such as polyvinylidene fluoride (PVDF), polyvinylidene fluoride trifluoroethylene (PVDF-TRFE), and parylene-C.

Carbon-based additive materials may consist of, but not be limited to, nanoparticulates such as single-walled carbon nanotubes (SWCNTs), multi-walled carbon nanotubes (MWCNTs) such as double-walled CNTs, triple-walled CNTs and the like, thin-walled carbon nanotubes (TWCNTs), graphene, graphene oxides, and carbon dots. The carbon-based additive materials act as conductive agents for active materials and polymeric binders with low electrical conductivities. The carbon-based additive materials can also provide structural support due to their high strength-to-weight ratio. Further, the carbon-based additive materials also act as an energy absorber for light or laser energy application methods due to their wide range of wavelengths for a high energy absorbance ratio.

The solvent may include, but not be limited to, water, N-methyl-2-pyrrolidone (NMP), dimethylformamide (DMF), dimethyl sulfoxide (DMSO), or a combination thereof.

A method of encapsulating active materials in a powder form, according to the disclosure, includes the following steps:
a. preparing an electrode slurry mixture containing the above-mentioned active materials, polymeric binder materials, carbon-based additive materials and solvent;
b. generating atomized mist of the electrode slurry mixture using nebulization methods, consisting of collision nebulization, ultrasonic nebulization or electro-spraying and the like, resulting in the generation of small droplets;
c. drying of the droplets in an air-suspended chamber and circulating droplets in air, using an infrared heater system, in which particles of polymeric binder encapsulated active materials are dried; and
d. applying energy to transform the dried particles of polymeric binder encapsulated active materials, resulting in:
   i. layers of a nano-porous structure following the evaporation of the solvent and polymers with a low boiling point, enabling easy lithium-ion diffusion;
   ii. carbonized outer surface layer providing structural hardness and electrical conductivity; and
   iii. inner surface layers of partially carbonized or non-carbonized polymers, providing an elastic deformable space for the active materials' volume change during a lithiation process.

A technique for applying energy according to the disclosure may include the radiation of electromagnetic waves such as a laser, microwaves, or intense pulsed light (IPL), or a Joule heating process to partially carbonize the polymeric binder materials.

A method of encapsulating active materials according to the disclosure includes coated electrode forms, using the following steps:
a. preparing an electrode slurry mixture containing the above-mentioned active materials, polymeric binder materials, carbon-based additive materials, and solvent, in which the powder form of encapsulated active material can be ball milled or freezer milled into a powder form after a post processing;
b. depositing the electrode slurry mixture on a current collector using a heated film coater; and
c. applying energy to transform the electrode slurry mixture to encapsulated active materials, consisting of:
   i. layers of a nano-porous structure following the evaporation of the solvent and polymers with a low boiling point, allowing of easy lithium diffusion;
   ii. carbonized outer surface layers providing structural hardness; and
   iii. inner surface layers of partially carbonized or non-carbonized polymers, providing an elastic deformable space for the active materials' volume change during a lithiation process.

Energy application methods according to the disclosure are described as follows: while the target samples are in
a. an air-suspended powder form, in a clear cylindrical chamber with a reflector covering the surface for maximum energy efficiency, and
b. in an electrode form, coated and calendared on a current collector, intense pulsed light is used.

The energy application methods according to the disclosure use a laser or microwaves, while the target samples are in
a. an air-suspended powder form, flowing in a small orifice at high speed where a laser or microwave is consistently irradiated at, and
b. in an electrode form, coated and calendared on a current collector.

The energy application methods according to the disclosure include electrical energy supply of Joule heating while the target sample is coated and calendared on the current collector in an electrode from.

A method of forming a composite of carbon and silicon or silicon oxide according to the disclosure uses carbon precursor materials including but not limited to pitch, mesophase pitch, isotropic pitch, asphaltene and more.

A method of preparing a mixture according to the disclosure includes mixing carbon precursor materials with silicon or silicon oxide in a solvent. Silicon or silicon oxide is dispersed within the mixture via stirring and sonication, and the solvent is dried. The mixing can be performed without a solvent, in a highly viscous state, using a ball mixer.

A method of carbonization according to the disclosure includes applying energy to the above-mentioned mixture via one or a combination of intense pulsed light (IPL), microwaves, IR, a laser or other techniques to generate silicon or silicon oxide embedded in carbon.

A method of preparing an electrode mixture according to the disclosure includes using an electrical spraying technique, to emulsify a mixture of the active material, carbon-based materials, polymeric binders, and solvent under an electric field, creating microspheres with a diameter less than 5 μm, before preparing an electrode slurry.

A method of manufacturing an electrode in another embodiment, to replace the above slurry preparation method, uses electro-spinning techniques to generate a polymeric fiber mat encapsulating the active materials, not in spherical coating but within the hollow structure of an electro-spun fiber. The mat of electro-spun fibers undergoes the above energy application process to form a mat of nano-porous carbonized fibers, encapsulating active materials within their hollow cores to suppress the volume change of the active materials during a lithiation cycle.

A method of manufacturing pre-lithiated anodes for improved Coulomb efficiency according to the disclosure includes the following steps:
a. pre-lithiating active materials in a powder form before encapsulation and carbonization processes;
b. pre-lithiaiting active materials in a powder form after encapsulation and carbonization processes;
c. pre-lithiating electrodes after electrode manufacturing and carbonization processes;
d. pre-lithiating electrodes by direct contact with lithium metal on the electrodes; and
e. pre-lithiating active materials in a powder form through the reduction of lithium by applying energy treatment to lithium salts.

According to the disclosure, active materials in a powder form are pre-lithiated before encapsulation and carbonization as described. Pre-lithiation is performed by mixing active materials in solid lithium at high temperature (above 200° C.), molten lithium or a lithium solution to form lithium-alloy active material particles such as LiₓS, LiₓSi, or LiₓSiOx. Then the pre-lithiated active material particles are dried using dry air, forming lithium oxide shell-covered lithium alloyed active material nanoparticles for stabilization. The pre-lithiated active materials are mixed with polymeric binders and carbon additives, and apply energy treatment such as IPL, microwaves, a laser, and Joule heating to produce encapsulated, multi-layered and nano-porous active material powder. A core of a multi-layered structure is the pre-lithiated active material. The encapsulated pre-lithiated powder are later used to fabricate electrodes via slurry deposition process.

In the method according to the disclosure, active materials encapsulated in the multi-layer of a nano-porous carbonized shell are pre-lithiated via the application of energy such as IPL, microwaves, a laser, and Joule heating. The particles of encapsulated active materials are mixed with solid lithium at high temperature (above 200° C.), molten lithium or a lithium solution to form lithium-alloy active material particles in the core. The nano-porous structure allows of the pre-lithiation of active materials within the core. The encapsulated pre-lithiated powder is later used to fabricate electrodes via a slurry deposition process.

In the method according to the disclosure, anodes are pre-lithiated after the encapsulation of active materials through the energy application such as IPL, microwaves, a laser, and Joule heating. The manufactured electrodes are pre-lithiated by submerging in molten lithium, placing in contact with lithium foils with electrical current supply, or submerging in a lithium solution.

In the method according to the disclosure, lithium metal is deposited on the electrodes to pre-lithiate the electrodes. This method has the effect of adding insufficient lithium to anode electrodes by depositing lithium metal on the electrodes before a cell is fabricated. When a cell with a cathode electrode and an anode electrode coated with lithium metal is charged and discharged for 1 cycle at 0.1 C, the active materials in the anode electrode are lithiated through an electrochemical process. The lithium metal deposition method includes physical vapor deposition (PVD), chemical vapor deposition (CVD), molten-lithium spraying, and thermocompression using a lithium thin sheet. The lithium metal deposited through the above method may melt through the energy application such as IPL and Joule heating to increase adhesion to the electrode, thereby enabling uniform pre-lithiation on the anode electrode.

In the method according to the disclosure, active materials in a powder form are pre-lithiated through the reduction of lithium by applying the energy treatment to lithium salts. This method uses a thermal reduction method in which the oxide of lithium is reduced to metallic lithium through heat treatment. When a metal possessing a great change in free energy of an oxidation reaction compared to lithium is used, lithium is reduced and the metal is oxidized. For example, when Si metal, which is an anode material, is used as a reducing agent, the oxide of lithium is reduced to lithium metal through the energy application such as IPL, microwaves, a laser, and Joule heating. In addition, depending on temperature from the energy application, Si surface can be coated with lithium metal, and pre-lithiated Si particles such as LiₓSiOₓ can be generated.

### DESCRIPTION OF DRAWINGS

Referring to the drawings, several aspects according to the present disclosure are illustrated by way of examples, and not by way of limitations, in detail in the drawings, wherein:

FIG. 1 shows results of comparison of the schematic structures of active materials encapsulated by polymeric binder materials, before and after an energy application process. The application of energy via intense pulsed light (IPL), a laser, microwaves, or Joule heating rapidly evaporates a polymer having a low boiling point, and escaping gas creates nanopores on the binder materials. Also, the surface of a polymeric binder is carbonized after the application of energy, while the inner layer of the polymeric binder remains as a soft polymeric binder;

FIG. 2 shows how the polymeric encapsulation and energy application of active materials prevent pulverization;

FIG. 3 shows the generation of piezo-electric charge, caused by the volume change of active materials;

FIG. 4 shows the generation of a nano-porous structure, from the application of energy;

FIG. 5 shows an electrical spraying process in an encapsulation process, and its application as a slurry;

FIG. 6 shows an electro-spinning process in an encapsulation process and its application as a mat;

FIG. 7 shows a process of drying active materials encapsulated in a suspended powder form, using an infrared (IR) heater;

FIG. 8 shows processes of applying IPL energy, to carbonize an outer surface and create a nano-porous structure on polymeric binders, and encapsulating active materials in suspended powder;

FIG. 9 shows a scanning electron microscopy (SEM) image of active materials encapsulated in polymeric binders. The nano-porous structure of encapsulating polymeric binders is clearly shown in this image;

FIG. 10 shows plots from energy-dispersive X-ray (EDX) and Raman spectroscopy that are performed on sample electrodes formed of active materials encapsulated in polymeric binders. The drawings in FIG. 10 show the formation of desired encapsulation layers, while showing peaks representing an active material (silicon), carbon for a carbonized surface and carbon-based additive materials as well as peaks for polymers;

FIG. 11 shows results of comparison of the electrical conductivity of different electrode materials, encapsulated in polymeric binders and processed with an energy application process. In FIG. 11, the application of energy via IPL, a laser, microwaves, or Joule heating results in a significant increase in the electrical conductivity of electrodes;

FIG. 12 shows results of comparison of the electrical capacitance of half-cells, before and after the use of the encapsulation method proposed in this disclosure. Samples encapsulated and treated with energy using the method described in this disclosure show better energy capacitance even after a large number of charging and discharging cycles;

FIG. 13 shows results of comparison of the electrochemical impedance of half-cells, before and after the use of the encapsulation method proposed in this disclosure. Samples encapsulated and treated with energy using the method described in this disclosure shows lower impedance in all frequency ranges; and

FIGS. 14 and 15 show pre-lithiations, specifically, pre-lithiation (FIG. 14) before encapsulation and carbonization, and a pre-lithiation method (FIG. 15) and a manufacturing process after encapsulation and carbonization.

### DESCRIPTION OF REFERENCE NUMERALS

100: Encapsulated active material
110: Active material (active material core)
115: Pre-lithiated active material
120: Polymeric binder
121, 221: Outer shell (carbonized polymer)
122, 222: Inner shell
125: Nanopore
130: Carbon-based additive
200: Carbonized active material
300: Pre-lithiated active material, encapsulated and carbonized
410: Low-boiling-point polymer
420: High-boiling-point polymer
501: Collision nebulizer
510: Substrate
601: Precursor solution
610: Fiber
710: Chamber
720: Atom nozzle
730: Infrared heater
735: Heat
740: Blower
801: Active material particulate
810: Chamber
820: Reflector
830: IPL lamp
835: Intense pulsed light (IPL)
840: Blower
1401: Pre-lithiaion solution
1402: IPL System
1403: Drier system
1415: Lithiated compound
1450: Additional polymeric binder

### MODE FOR INVENTION

The following description and the embodiments set forth herein are provided by way of the illustration of an example, or examples, of particular embodiments of the principles of various aspects of the subject matter of this disclosure. These examples are provided for the purposes of description, and not of limitation, of those principles and of the subject matter in its various aspects. In description, similar parts are marked throughout the disclosure and the drawings with the same respective reference numerals. The drawings are not necessarily to scale, and in some instances, proportions can increase in order to depict certain features more clearly.

### 1. Expansion of Active Materials

Silicon, along with aluminum, tin and sulfur, is considered one of the future active materials for lithium-ion battery electrodes because of its high energy capacity. Graphite, which is the most commonly used anode material today, reacts with lithium ions through an intercalation process, allowing of a maximum of one lithium ion stored per a ring of six carbon atoms at 372 mAh/g [Obrovac, 2018]. On the other hand, silicon reacts with lithium ions through an alloying process, and is known to allow of a maximum of 15 lithium ions stored in a chain of four silicon atoms at 3579 mAh/g [Obrovac and Krause, 2007].

However, silicon or other active materials which go through metal alloying reactions during repeated lithiation processes have inherent problems. The formation of lithium-silicon alloys causes a large volume expansion up to 280% [Lee at al. 2012], resulting in various problems. High mechanical stress applied to the active materials causes a fracture and pulverization, electronic isolation from a conductive agent, the formation of unstable solid electrolyte interphase (SEI), and the trapping of lithium ions, which all lead to a loss of energy capacity and electrical performance [Obrovac and Chevrier, 2014]. Table 1 shows results of comparison among the theoretical energy capacities and the volume expansion rates of different active materials in the lithiation processes.

TABLE 1
Comparison of theoretical capacity and
volume change in active materials

| | |
|---|---|
| Theoretical | Volume |
| capacity (mAh/g) | change (%) |

Anode materials

| | | |
|---|---|---|
| Silicon | 3,600 | 320 |
| Aluminum | 2,235 | 604 |
| Tin | 990 | 252 |
| Graphite | 372 | 10 |

Cathode material

| | | |
|---|---|---|
| Sulfur | 1,675 | 80 |

To solve the volume expansion and problems caused by the volume expansion, various solutions have been suggested. One solution is the nanoparticulation of active materials, using only active materials smaller than 50 nm, to prevent pulverization. Reducing dimension scales, such as a particle size or a film thickness, results in a decrease in the release rate of strain energy, thereby suppressing a fracture. However, the active materials still undergo a large change in volume, applying an unwanted pressure to an internal battery structure as well as packaging.

Another potential solution is to put structural support to suppress the volume expansion. There are several intellectual properties and published academic papers using carbon nanotubes (CNTs) mixed within electrode materials to suppress the volume change. CNTs have very high tensile strength compared to their extremely light weight, and they also have high electrical conductivity, acting as conductive networks to minimize a loss of electrical performance even if the volume expansion occurred. In a study, silicon nanobeads strung together using a CNT in a rope-like fashion so that silicon always remains in contact with a CNT framework [Sun et al. 2013]. This ensures a constant electrical connection to CNTs and prevents a crack by promoting controlled expansion and contraction during lithiation/de-lithiation cycles. Similar CNT frameworks have also been implemented in different ways to produce the same effect through simple dispersion in CNT networks as opposed to embedding. Si nanoparticles can be coated with amorphous carbon and then dispersed in a CNT network through a simple mix [Xue et al. 2012]. Galvanostatic charge-discharge tests show the addition of CNTs achieved greater stability by preventing a crack and pulverization caused by a significant volume change in an electrode.

However, these methods are known to be expensive, energy intensive, or require a long processing time. The embodiments set forth in this disclosure utilize cost-effective methodologies to encapsulate active materials while achieving the desired traits of the suppression of volume expansion, the prevention of pulverization, and the stabilization of a nano-porous structure and solid electrolyte interphase (SEI).

### 2. Encapsulation of Active Materials

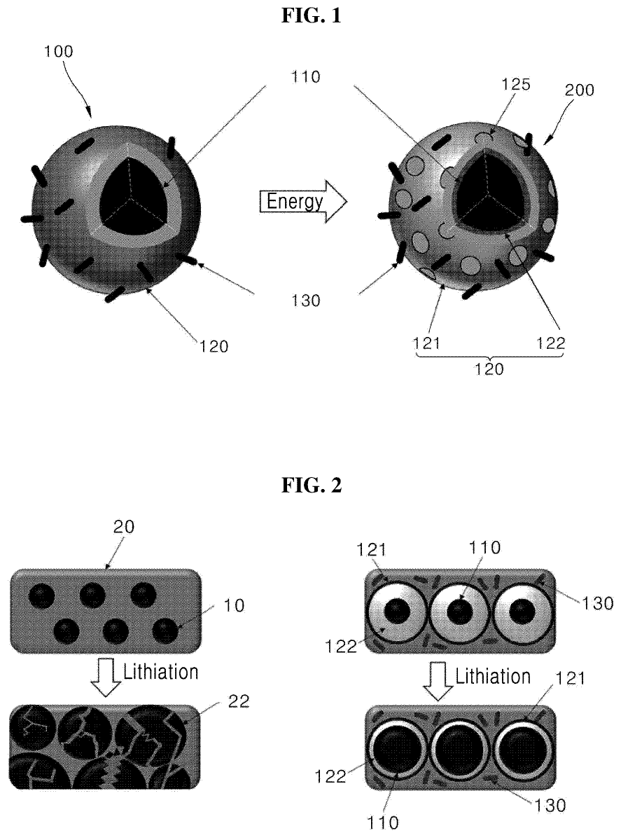

In this disclosure, introduced is the polymeric encapsulation of active materials to suppress the volume expansion of the active materials and resulting side effects such as a fracture, pulverization and a loss of electrical performance. The goal is to create a multi-layered encapsulating structure. FIG. 1 schematically shows the structure and the manufacturing process of encapsulated active materials.

Referring to FIG. 1, in a manufacturing method of an electrode according to the present disclosure, active materials 110 are encapsulated by polymeric binders 120, and then carbon-based additives 130 are dispersed in the polymeric binders 120.

The encapsulated active materials 100 comprise an outer shell 121 and an inner shell 122 as a result of the application of energy, and active materials 200 having nanopores 125, which are encapsulated and carbonized, are manufactured. The carbonization based on the application of energy is performed only in some of the polymeric binders 120. Thus, the polymeric binders 120 may include the outer shell 121, and the inner shell 122. The outer shell 121 is carbonized and hard. The outer shell 121 provides electrical conductivity while providing structural support and forms a solid electrolyte interphase that is stable and thin. The inner shell 122 between the outer shell 121 and a core active material 110 is filled with a soft polymer that is not carbonized, and reduces mechanical stress caused by the volume change in the active materials during the lithiation and de-lithiation processes. A plurality of nanopores 125 is formed in the polymeric binders 120 and helps lithium ions to be easily diffused.

FIG. 2 shows how the polymeric encapsulation and energy application of active materials prevent pulverization.

On the left side of FIG. 2, active materials 10 are covered with a polymeric binder 20 for fixing the active materials on a current collector. In this case, the active materials 10 can expand in the lithiation process, and large stress applied to the active materials can cause pulverization 22 to the active materials.

On the right side, active materials 110 are encapsulated 121, 122 by polymeric materials and processed with the application of energy. An outer shell 121 consists of hard binders that are carbonized, and an inner shell 122 is filled with soft polymers that is not carbonized. A polymeric binder 10 outside the outer shell 121 is to fix the active materials, which are encapsulated and carbonized, onto a current collector after the carbonization process. The active materials can expand in volume, but stress can be absorbed by the inner shell 122 filled with soft polymers.

In the following section, materials for encapsulation and a method for producing a desired multi-layered structure are described. First, the way in which actives materials are encapsulated and prepared in a powder form is described. Then the electrode manufacturing process is described, using the encapsulated powder, or using raw materials encapsulated after electrode deposition, or using an alternative method to form an electro-spun mat of an electrode.

### 2.1 Production of Encapsulated Powder of Active Materials

In this process, active materials with a large volume expansion ratio are encapsulated with polymeric binders and processed to produce multi-layered encapsulated powder. The produced powder would be readily available for an ordinary manufacturing process used for the production of electrodes.

### 2.1.1 Materials

The encapsulated active materials use the following categories of materials to produce a desired structure: active materials, polymeric binders, carbon-based additives and a solvent. For polymeric binders, four potential types of polymers were used, and they are polymers for nano-porous structure generation, double-network (DN) hydrogels, active element containing polymers and piezoelectric polymers.

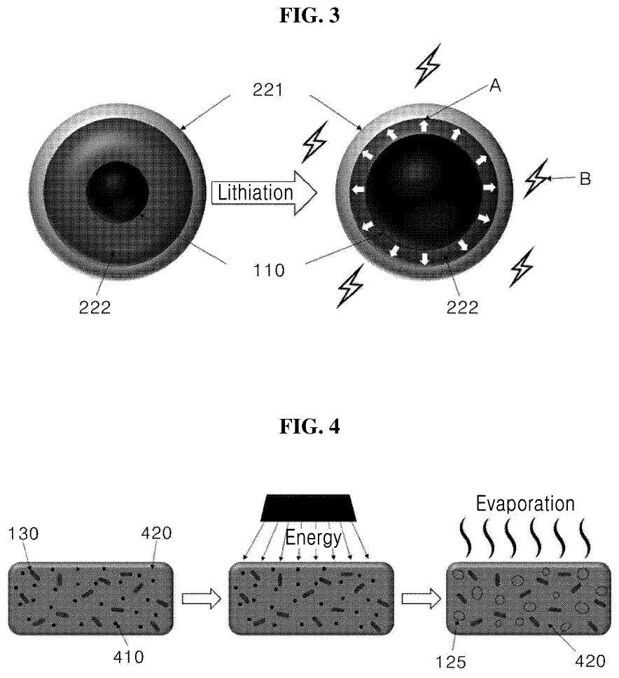

For example, FIG. 3 shows the generation of piezoelectric charges, caused by a volume change of active materials, when piezoelectric polymers were used as a polymeric binder.

The active materials in FIG. 3 include an active material core 110, and piezoelectric binder shells 221, 222 that encapsulate the active material core 110. The piezoelectric binder shells include an outer shell 221 that is carbonized, and an inner shell 222 that is not carbonized. Since the non-carbonized inner shell 222 is filled with piezoelectric binders, internal stress is produced due to the volume expansion of the active materials at a time of lithiation (A). Thus, charges would be produced (B).

Polymeric materials comprising the piezoelectric binders, usable in this disclosure, and their roles in a lithium secondary battery are specifically described hereafter.

### Active Materials

The active materials in need of encapsulation have large volume expansion rates. This is mainly because of the lithiation mechanism of these active materials. For example, silicon, the promising anode material with theoretical capacity of 3,600 mAh/g, has a volume expansion ratio of 320%, due to the metal-alloying lithiation mechanism. Similarly, sulfur is considered a promising cathode material, forming lithium polysulfide with theoretical capacity of 1,675 mAh/g, at a volume expansion ratio of 80%. In this disclosure, described mainly are the processes optimized for enhancing the electrochemical properties of electrodes based on silicon or sulfur. However, the processes are not limited to silicon and sulfur, and are applicable to other active materials such as aluminum and tin as well.

### Polymeric Binders

Polymeric binder materials are main materials encapsulating active materials. Conventionally, binders hold the active materials within an electrode together, and adheres the electrode to the current collector. However, with the emergence of silicon as a promising active material, polymeric binder materials are considered to be the key to the alleviation of volume expansion, maintain integrity and stabilize charging and recharging cycles. In this disclosure, we introduced encapsulating layers of polymeric binders, processed with energy for desired structures of nano-porous, hard shelled and internally soft layers.

### Polymeric Binders for Nano-Porous Structure

In conventional lithium-ion batteries, the charging and discharging rates of a battery are an important factor in determining battery performance, along with stability and energy capacity. Generally, the lithiation process at an anode has been slower than the de-lithiation process at a cathode; and a slow lithiation rate at graphite anodes especially caused more problems such as lithium precipitation [Liu et al. 2019].

In graphite, techniques have been used to improve the lithiation rate, and many of the techniques involved increasing a diffusion rate of lithium ions via creating pores within the graphite structure. Cheng and others [Cheng et al. 2015] etched graphite using potassium hydroxide (KOH), created holes in the surface of pristine graphite. This increased the number of lithium accessible holes with a reduced specific area, and decreased lithium-ion diffusion distances, resulting in enhanced coulombic efficiency, rate capability and cyclability [Cheng et al. 2015]. Similarly, Chen and others used a laser patterning technique to create patterned holes on the surface of graphite. These holes provided linear or short diffusion paths for lithium ions so that the ions could be transferred fast [Chen et al. 2020].

Even in the case of silicon active materials, a metal alloying active material, also benefits from accessible and interconnecting pores since highly porous matrix provides more paths for lithium ions to reach the active materials [Antartis et al. 2015]. Antartis and others showed that an anode made of a tin (Sn)/PVDF/AB (Acetylene black) composite increased its energy capacity with increasing porosity, showing its maximum capacity at the porosity larger than 44% [Antartis et al. 2015].

As mentioned above, it is important to provide accessible paths for lithium ions, especially because the active materials are encapsulated within polymers. The question is how to generate a porous encapsulating structure for active materials.

For example, Sohn and others used chemical etching that uses a sodium hydroxide (NaOH) solution to create pores in non-porous Si—C composite powder [Sohn et al. 2016]. While this method created a porous structure within the Si—C structure, the method involved etching silicon and carbon simultaneously. Also, the process involved mixing alkaline and acidic solutions with the powder to etch the mixture and then to neutralize it, adding additional procedures.

In a more direct method, Shao and others suggested a nanocomposite structure in which silicon nanoparticles were encapsulated with porous carbon. The silicon nanoparticles were individually coated with porous carbon shells, having a thickness of 15-20 nm and a pore size of 3-5 nm [Shoo et al. 2013]. Shao and others achieved the structure by carbonizing glucose while using Pluronic F127 ((C₃H₆O·C₂H₄O)x) as a pore foaming agent. The application of a high temperature (700° C.) for a long duration (12 hours) turned glucose into carbon while Pluronic F127 evaporated and left a porous structure within the carbonized glucose. This method was not favorable since the high energy and long duration are required, but the idea laid the foundation for this disclosure.

In this disclosure, we used mixtures of two or more polymers and copolymers having different boiling points for the formation of a nano-porous structure. In theory, the application of thermal energy via various methods could lead to the evaporation of polymers having lower boiling points along with a solvent; thereby leaving nano-porous structures of polymers with high boiling points. These polymers, as described in the Claim section, comprise mixtures of two or more polymers and copolymers having different boiling points. The mixtures of the polymers may include different combinations of two or more of the following, but not be limited to, polyacrylonitrile (PAN), Polytetrafluoroethylene (PTFE), poly(methyl methacrylate) (PMMA), poly(3,4-ethylenedioxythiophene) polystyrene sulfonate (PEDOT:PSS), Polydiacetylenes (PDAs), polypropylene (PP), polystyrene (PS), polyurethane (PU), polyethylene oxide (PEO), polyethylene terephthalate (PET), Styrene-ethylene-butylene-styrene (SEBS), polyvinyl alcohol (PVA), glycerol, sucrose, asphaltene, meso-phase pitch, cellulose, and lignin, but not be limited.

FIG. 4 shows the generation of a nano-porous structure from the application of energy when two sorts of polymeric binders having different boiling points are used.

Referring to FIG. 4, carbon additives 130 are dispersed in polymeric binders 410, 420. For example, low-boiling-point polymers 410 can also be disposed in a powder form in high-boiling-point polymers 420. When energy is applied, unlike the high-boiling-point polymers 420, the low-boiling-point polymers 410 evaporate rapidly. Accordingly, the places of the low-boiling point polymers 410 turn into nanopores 125.

### Double Network Hydrogel as Binders

Another potential material for polymeric binders is a double network (DN) hydrogel. Hydrogels have three-dimensional cross-linked network structures and high flexibility, and contain a high percentage of water. Due to the biocompatibility and functionality, hydrogels were utilized in various application fields, including tissue engineering, drug delivery, soft actuators and even sensors. However, hydrogels suffered from its poor mechanical properties [Chen et al. 2020]. In order to overcome the weakness, researchers have developed various types of self-healing hydrogels, including a double-network hydrogel [Basu et al. 2017]. The self-healing double-network (DN) hydrogels consist of conventional covalently crosslinking polymers and another network with renewable bonding. Their self-healing property and enhanced mechanical property, on top of their ability to transfer ions, intrigued battery researchers as a potential candidate for a solid electrolyte [Duan et al. 2018; Wu et al. 2018] as well as the polymeric binder materials [Gendensuren and Oh 2018].

Gendensuren and Oh used alginate grafted with polyacrylamide (PAAm) and crosslinked them both physically and chemically, creating dual-crosslinking bonds. The dual-crosslinks were formed also when Alg-g-PAAm was mixed with the slurry of active materials (silicon and graphite). Gendensuren and Oh reported that Alg-g-PAAm greatly enhanced the adhesion between active materials and the current collector, and further enhanced the adhesion when the binder was crosslinked. Most importantly, the crosslinked Alg-g-PAAM showed exceptional characteristics in suppressing the volume change of Si—C electrode. When only Alg was used as the binder, the volume expansion rate of Si—C electrode reached up to 451%, but the use of crosslinked Alg-g-PAAm as the binder suppressed the volume expansion rate to 97%. Furthermore, the crosslinked Alg-g-PAAm binders showed improved both the reversible capacity and the Coulombic efficiency of the Si—C electrode, undergoing large volume changes [Gendensuren and Oh 2018]. Thus, in conclusion, DN hydrogels are potential candidates for polymeric binders to encapsulate active materials.

In this disclosure, we investigated the potential application of DN hydrogels as a polymeric binder material encapsulating silicon active materials. DN hydrogels may include combinations of carboxylmethyl cellulose (CMC) and polyacrylic acid (PAA), polyacrylic acid (PAA) and polyethylene glycol (PEG), polyacrylic acid (PAA) and polyethylenimine (PEI), polyacrylic acid (PAA) and chitosan, styrene/butadiene copolymer (SBR) and polymethyl methacrylate (PMMA) and more.

### Active Element Containing Polymer

In an effort to minimize the capacity degradation caused by the volume changes in the lithiation and de-lithiation cycles of silicon, silicon-based polymer derived ceramics have been studied due to their high resistance to crystallization and possessed amorphous carbons [Liebau-Kunzmann et al. 2006]. Electrodes made of silicon carbon nitrides (SiCN) [Graczyk-Zajac et al. 2010], silicon oxy-carbides (SiOC) coated silicon nanoparticles [Choi et al. 2014], SiOC [Halim et al. 2016], a composite of silicon, carbon and silicon oxy-carbides [Vrankovic et al. 2017], a composite of SiCN and graphite [Graczyk-Zajac et al. 2011] have shown promising stability and cyclability as a silicon-based electrode. Idrees and others concluded that these materials show promising results because of their porous structure accommodating the volume change and high conductivity due to the existence of carbon [Idrees et al. 2019]. Therefore, precursor materials and their pyrolysis process conditions could largely affect the structure and carbon composition of the electrodes, directly determining resultant electrochemical performance [Riedel et al 2013; Su et al. 2009; Fukui et al. 2013].

In this disclosure, we suggest using organosilicons, precursor materials for silicon based polymer derived ceramics, and sulfur containing polymers, for the polymeric binder materials encapsulating the corresponding active materials (silicon and sulfur). Organosilicons such as polysiloxanes, polysilsequioxanes, polycarbosiloxanes, polyborosilanes, polysilycarbodiimides, and sulfur containing polymers such as polysulfoxide and poly(sulfur nitrides) could be turned into SiOC, SiC (silicon carbide), SiCN, SC (sulfur carbide), and SCN (sulfur doped carbon nitride) with great electrochemical performance, while encapsulating the active materials (silicon and sulfur). These materials are already reported as an electrode material by themselves, and we expect them to perform their role as a binder material as well as an additional lithiation site to further increase the energy capacity by providing active sites. The pyrolysis process, however, will be following new techniques other than the ordinary pyrolysis techniques as described below.

### Piezoelectric Polymer

While the volume expansion of active materials is generally considered a negative trait, efforts have been made to take advantage of the volume changes during a lithiation cycle. Lee and others reported that the user of a piezoelectric material, namely, barium titanate (BaTiO₃) nanoparticles, mixed in a silicon-CNT electrode, improved the electrochemical performance of the electrode [Lee et al. 2016]. According to Lee and others, the internal stress caused by the volume expansion of the electrode activated the piezoelectric particles, and an increase in the piezoelectric potentials increased the lithiation rate. It resulted in a shorter time in both the charging and discharging processes, compared to electrodes with no piezoelectric materials [Lee et al. 2016].

Similarly, it is proposed to use polymeric binders with piezoelectric properties to enhance the electrochemical performance of lithium-ion batteries. This embodiment presents a list of potential polymers with piezoelectric properties consisting of, but not limited to, semicrystalline polymers such as polyvinylidene fluoride (PVDF), polyvinylidene fluoride trifluoroethylene (PVDF-TRFE), and parylene-C.

The piezoelectric polymers, especially, PVDF, requires a phase transition to a beta phase for it to have a crystalline structure with piezoelectric properties. Electrical poling is a well-known method to induce the beta phase transition of PVDF [Sanaa et al. 2018]. However, it is also known that thermal annealing could induce the beta phase transition of PVDF depending on annealing conditions [Satapathy et al. 2008].

### Carbon-Based Additives

Silicon and sulfur, active materials suggested for encapsulation, both have low electrical conductivity. Carbon-based additives, such as carbon blacks, graphite, carbon nanofibers (CNFs), carbon nanotubes (CNTs), graphene, and graphene nanoplatelets (GNP) are commonly used for enhancing electrical conductivity of electrodes. The carbon-based additives are favorable over other metallic conductive additives, because of their high conductivity, light weight, and chemically stable nature. Some of them, such as carbon nanotubes, carbon nanofibers, grapheme, and the like, are capable of forming a conductive network only with a small amount due to a high aspect ratio and electrical percolation.

Furthermore, the carbon-based additives serve additional purposes in the proposed encapsulation method. The carbon-based additives are known to increase electromagnetic absorption and reduce electromagnetic reflectance [Kong et al. 2014]. In this disclosure, we utilize the irradiation of electromagnetic energy such as intense pulsed light (IPL), microwaves, and lasers, to change the structure and properties of encapsulation layers. Thus, adding the carbon-based additives reduces required energy by increasing absorbance of IPL, microwave or lasers required for the formation of a nano-porous structure and the carbonization of an encapsulating polymer. Several studies have shown that CNTs have been incorporated into metal inks to improve IPL sintering performance due to their innate ability to absorb IPL [Kim et al. 2017]. Especially, CNTs showed a good ability to absorb light having wavelengths between 400 and 1000 nm as confirmed with UV-Vis measurements. Graphene nanoplatelets (GNPs) also showed high electromagnetic radiation absorbance [Verma et al. 2017]. Hybrids of GNPs and multi-walled carbon nanotubes (MWCNTs) were especially beneficial for microwave absorption owing to polarization differences (Chen et al. 2016).

The carbon-based additives are embedded to polymeric binders that encapsulate active materials, providing enhanced electrical conductivity and energy absorbance. Furthermore, their high tensile strength could provide additional structural support to suppress the volume expansion of the active materials.

### 2.1.2 Encapsulation Process

In this section, we describe how to prepare active materials encapsulated with a desired multi-layered hard conductive outer shell along with a soft polymer inner shell in the nano-porous structure. The processes involve general steps of mixing materials, generating particulates, drying mixed powder, and finally applying energy for carbonizing an outer surface and generating a nano-porous structure.

### Mixing

The slurry of active materials, encapsulating polymeric binders, carbon additives and solvents were mixed together using a ball mill. Silicon nanoparticles having an average diameter of 100 nm were mixed with polyacrylic acid (PAA), COOH functionalized multi-walled CNTs, and N-Methyl-2-Pyrrolidone (NMP). The mixing process included 3 hours of ball milling and 2 minutes of ultrasonication.

### Generation of Particulates

In order to create powder of individually encapsulated active materials, the particulates of the mixtures need to be generated before the drying and the application of energy. The particulates can be generated from the mixture using various methods, including the Collison nebulization, piezoelectric nebulization, ultrasonic spraying or electro-spraying methods.

A collision nebulizer was first developed by K. R. May in 1972 [May 1972], and has long been recognized as an aerosolization technique for various liquids. In the Collision nebulizer, air moves at high velocity through the nebulizer's small orifice, then suctions liquid from the nebulizer's jar and breaks it apart into small droplets. The atomized liquid bumps against the walls of the jar and then generates even smaller droplets. Larger particles are removed from the aerosol by a curved outlet tube [CH Technologies 2017].

A piezoelectric nebulizer and an ultrasonic nebulizer both utilize a piezoelectric transducer to generate atomized particles. The application of high-frequency voltages to the transducer induces high frequency vibrations to the transducer. In the ultrasonic nebulizer, liquid is placed on the piezoelectric transducer's surface, and the vibrations are applied to the liquid via the transducer. The vibrations form capillary waves (standing waves) in the liquid, where small droplets are released from the mass of the liquid in the form of aerosol. In the ultrasonic nebulizer, the sample principle applies, as the liquid is atomized when it reaches the surface of a vibrating nozzle. The size of atomized particles depends on the applied vibration frequency. For the creation of nanometric particles generation, vibrations at frequencies in a few megahertz (MHz) range are required. Due to geometric constraints, the ultrasonic nebulizers are more common in a range of a few megahertz, while sprayers are more limited to tens of kilohertz.

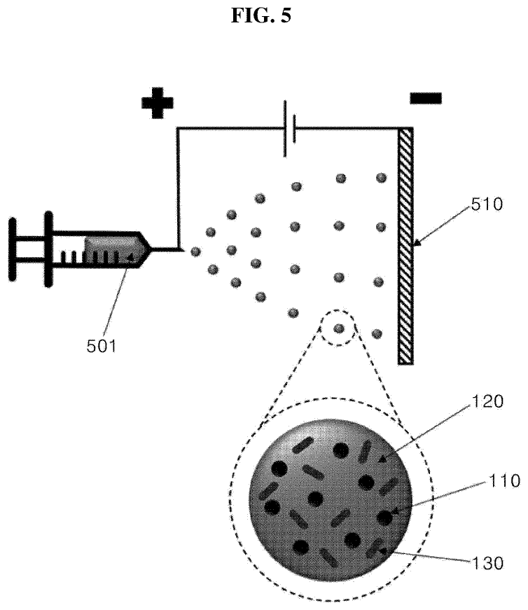

FIG. 5 shows an electrical spraying process in an encapsulation process, and its application as a slurry.

According to the present disclosure, FIG. 5 shows that active materials 110 are encapsulated in polymeric binders 120 as a result of electrical spraying using a Collison nebulizer 501, that active material particulates encapsulated are generated, and that carbon-based active materials 130 are dispersed in the polymeric binders 120. Additionally, FIG. 5 shows that the active material particulates encapsulated are applied to a substrate 510 such as a current collector.

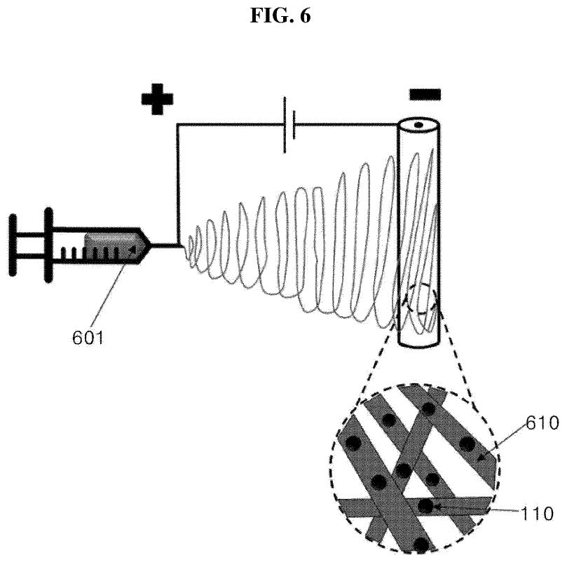

FIG. 6 shows an electro-spinning process in an encapsulation process and its application as a mat.

In the process of manufacturing an electrode for a lithium secondary battery according to the disclosure, the electro-spinning method in FIG. 6 can be used as a method of encapsulating active materials. Polymeric binders form strong fibers 610 as a result of the electro-spinning of a precursor solution 601 comprising active materials, polymeric binders, carbon-based additives and a solvent, and encapsulate the actives materials 110 in the fibers 610. A mat of fibers fabricated through the electro-spinning process requires no additional coating process, and can be placed on top of the current collector as an electrode layer as it is.

In an experiment, a mixture of silicon nanoparticles as an active material, PAA as a polymeric binder, acid-modified multi-walled CNTs as a carbon-based additive, and water as a solvent was placed in a Collison nebulizer 501 and then atomized by running compressed air. Sprayed particulates were collected and dried in a specially designed drier system.

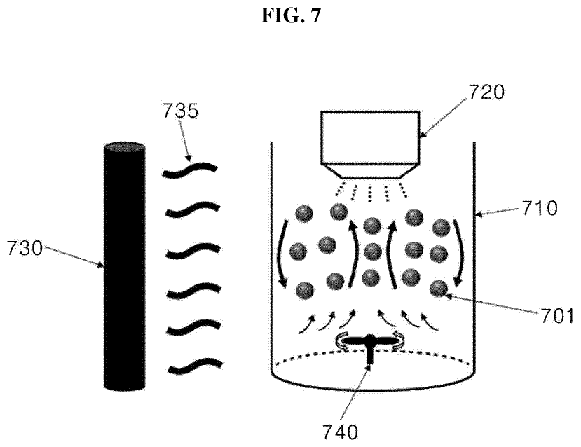

FIG. 7 shows an example of a drier system schematically. The illustrated drier system comprises a transparent cylinder-shaped chamber 710, an atom nozzle 720 for providing encapsulated active materials, an infrared heater 730 for applying heat 735 to the encapsulated active materials, and a blower 740 for continuously suspending the encapsulated active materials in the transparent cylinder-shaped chamber 710.

In the drier system illustrated in FIG. 7, particulates sprayed through the atom nozzle 720 were continuously suspended in air by circulating the air through the blower 740 in the transparent cylinder-shaped chamber 710 that is sealed, and irradiated with the infrared (IR) heater 730 for drying (see FIG. 7). The dried nanoparticles were collected, and as they were collected, experienced an additional IPL process and then were observed using a scanning electron microscope (SEM).

### Irradiation of Energy

In order to carbonize the outer shell and create a nano-porous structure on the encapsulating polymeric binders, energy needs to be applied. In a conventional method, the application of thermal energy via pyrolysis has been most common, but usually consume large amounts of energy and time. In this disclosure, intense pulsed light (IPL), microwave (MW), laser and Joule heating techniques are adopted to create a desired multi-layered structure of encapsulation. In a powder form, however, the IPL technique is more applicable.

Intense pulsed light (IPL) is one of many energy application techniques, specifically using rapid irradiation photo-electromagnetic waves generated from a xenon lamp. The application of a high intensity pulse of electricity through a xenon gas charged lamp results in photon irradiation as xenon gas is excited to a higher energy state then drops back to a lower state. The irradiated energy in the form of intense pulsed light is also known as flash. The IPL technique has advantages over other electro-magnetic energy application processes such as lasers and microwaves because of its coverage of a large surface area within a short period of time. Also, IPL has a broad spectrum of pulsed light, generally ranging from 200 to 1100 nm, whereas laser or microwave techniques have a more specific spectrum of wavelengths. Modern IPL devices utilize computer-controlled capacitor banks to generate IPL where its pulse duration, pulse intervals, number of pulses, and intensity are manipulated. Fluence (radiation energy received by a surface per unit area) is related to a distance from a source of energy to a target surface, an angle of reflectors and absorbance of the target surface. As it is mentioned in section 2.1.1, carbon additives having high absorbance in a wide spectrum are present within the mixture encapsulating the active materials, and turns absorbed energy into thermal energy for the carbonization of a polymer and the generation of a nano-porous structure.

The IPL process is considered to be a more applicable energy application method for encapsulated active materials in a powder form, since IPL can cover a large surface area at once. Lasers focused on a small specific area, or Joule heating requiring an electrically conductive network cannot apply energy to all surfaces of air-suspended colloids of encapsulated active materials. Additionally, typical IPL systems emit light in a spectrum between 200 to 1100 nm with pulse durations in few milliseconds and the resulting energy density of 12 J/cm 2 [Kramer, Wunderlich, and Muranyi 2017]. Considering a typical IPL system, a diffusion depth of IPL irradiation is limited to approximately 1 μm from a surface. Such a limited diffusion depth may not be favorable if a bulk material was to be processed. However, in this application, this would enable a desired multi-layered structure as it would carbonize the outer shell with high energy, but would leave a soft polymeric inner layer since the energy could not diffused into the core.

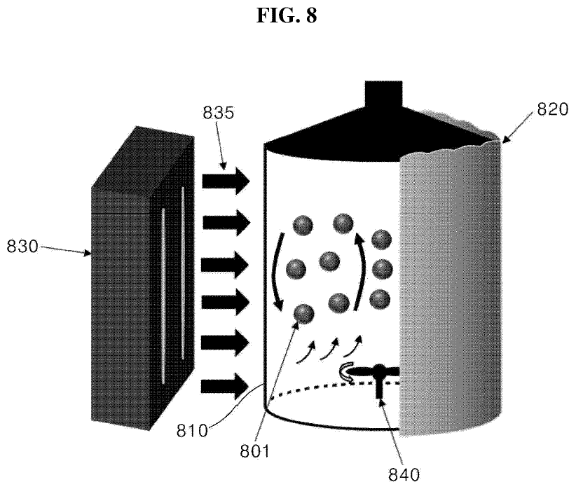

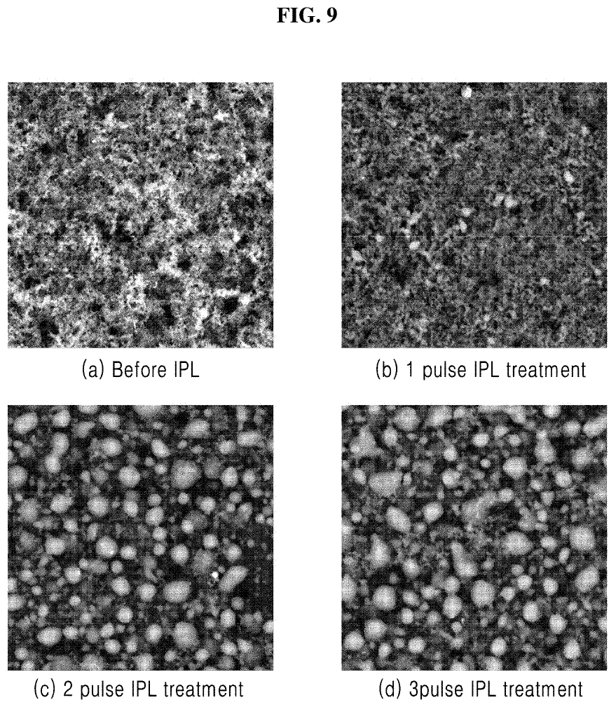

FIG. 8 shows an example of an IPL irradiation device for encapsulated particles that are suspended in air.

Referring to FIG. 8, for the powder 801 of the encapsulated active materials to be irradiated with IPL 835's energy evenly, a specially designed chamber 810 is used to suspend dried encapsulated particulates 801 in air through the blower 840. The chamber 810 is made of a light transmitting material (glass, or transparent polycarbonate etc.). The blower 840 suspends the active material particulates 801 in air, via a continuous blow. An IPL lamp 830 is disposed to face the chamber 810 using a xenon lamp, while the other side of the chamber 810 is covered with a reflector 820 to irradiate all sides of the active material particulates from the IPL process.

FIG. 9(a) is an SEM image of dried nanoparticles before the application of energy. A mass median diameter (MMD) of the dried nanoparticles was approximately 10s of nm to 100s of nm, and polymeric materials encapsulated individual silicon nanoparticles. Considering a diameter of the silicon nanoparticles used, the encapsulated polymers are expected to have an average of a few nm in thickness.

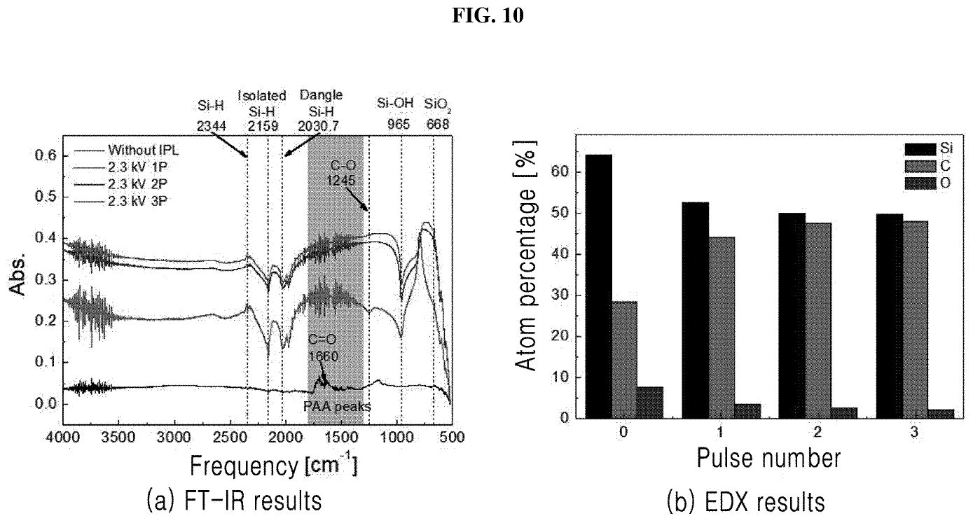

FIG. 10 shows plots from energy-dispersive X-ray spectroscopy (EDX) and Raman spectroscopy that are performed on sample electrodes formed of active materials encapsulated in polymeric binders. The EDX analysis on backscattered X-rays shows that peaks for oxygen atoms are decreasing in number, but peaks for carbon atoms are increasing. This means the polymeric outer shell containing oxygen has carbonized via an IPL process (see FIGS. 10(a) and 10(b)). The FT-IR analysis, unlike the EDX, can scan an internal structure through a nano-porous structure. In FT-IR analysis, silicon-related peaks around 965 nm, 668 nm and 615 nm are clearly shown after the application of IPL. Further, peak intensity has clearly increased for C—C bonds (approximately 2344 nm) after the application of IPL, indicating the carbonization of the materials. The presence of C═O bonds around 1660 nm in all cases could also indicate that there is a polymeric layer of PAA still remaining inside, while the surface has become highly carbonized as indicated by EDX measurements.

### Laser

Energy application via a laser is also utilizing electromagnetic waves; but a laser has a narrow spectrum of wavelengths rather than having a broad spectrum of wavelengths. A specific range of wavelengths is variable depending on a laser source. Commonly available Nd:YAG (neodymium-doped yttrium aluminum garnet) lasers operate at a wavelength of 1,064 nm, while another commonly available CO₂ (carbon dioxide) lasers operate near 9.6 μm. Another difference of a laser from IPL is that a laser usually has a small spot area of irradiation (a typical size of about 1.0 mm). This is more advantageous for focused energy application, but its application to a large surface area such as a battery electrode requires the scanning of the area. Due to its highly focused energy in a short time (a few milliseconds), a laser is often used for the carbonization of carbon precursor materials. A time scale of the laser carbonization process, in comparison to a few hours of conventional pyrolysis technique, is also known to suppress an oxidation reaction even in the atmospheric environment. In this disclosure, the selective laser carbonization technique is one of the application methods of potential energy, which are applied after an electrode is fabricated from a slurry mixture.

### 2.2 Fabrication of Electrode

The electrochemical performance of lithium-ion batteries fabricated using methodologies suggested in this disclosure needs to be verified in the form of an electrode. In this section, three different methods of fabricating an electrode are described; where one uses the aforementioned powder of encapsulated and energy-processed active materials, another uses the slurry of a mixture coated and processed via the application of energy, and the other uses a mat of electro-spun and carbonized materials.

### 2.2.1 Electrode from Encapsulated Powder

Powder of active materials encapsulated with polymeric binders and processed via the application of energy are used to make an electrode. A slurry mixture is produced by mixing the powder from section 2.1.2, with polymeric binder materials, carbon-based additives, and a solvent, then coated on the current collector (a copper film) using a film coater, and dried in a vacuum oven under a 110° C. atmosphere. The slurry mixture is produced at a ratio of 80-90% of active material powder to 5-10% of carbon-based additives to 5-10% of polymeric binder materials. The solvent may vary depending on the viscosity of a slurry mixture. The coated slurry is dried in vacuum, and then processed and compressed in a calendaring process.

### 2.2.2 Electrode from Slurry Mixture

The encapsulation and the energy application of active materials can be performed in a coated electrode layer. First, a slurry mixture is prepared by mixing active materials, polymeric binders, carbon-based additives and a solvent. For the experiment, silicon nanoparticles having a diameter of 100 nm, and PAA and COOH-functionalized MWCNTs (commercial multi-walled carbon nanotubes having 10-15 walls) were mixed together at a weight ratio of 85:5:10 in an NMP solvent. The mixture was ball-milled for 3 hours and sonicated with an ultrasonicator for 2 minutes to promote an evenly dispersed mixture. The prepared slurry was coated on the current collector using a film coater (TMAX-H200T) at 100° C. The deposited/sedimented slurry was dried in a vacuum oven for 30 minutes, and then processed with an energy application method. In this experiment, the IPL method was used, but in the electrode coated form, other techniques such as lasers, microwaves and Joule heating are also available.

For an exemplary experiment, IPL was used at 2,200 V for a duration of 6 ms at a distance of 2 cm. Similar to the structure of a neural network, some embodiments of the present disclosure implement the design of a tertiary structure for a Si/CNT anode (FIG. 9). Si/CNT NPs are contained within spherical or spheroidal, micron-sized, porous carbon frameworks (or other encapsulating structures). As shown in FIG. 9(a), before IPL treatment, Si nanoparticles with a size of 100 nm surround MWACNTs having a diameter of 30 nm. Upon IPL treatment of 2.2 kV and 6 ms, Si around ACNTs began to agglomerate. In the first IPL treatment, Si nanoparticles were aggregated to form Si colonies having a size of hundreds of nanometers. As the number of the IPL treatments increased from 2 to 3, Si colonies increased from 2 to 4 μm, and the amount thereof is increased. Additionally, through the IPL treatment, a nanoscale-thick multi-wall carbon nanotube framework connects individual Si colonies. Further, the Si colonies generated through the IPL treatment are connected through the nanoscale multi-wall carbon nanotube framework. This structure similar to the form of a neural network can facilitate the transfer of electrons.

FIG. 10(a) shows the FT-IR results of Si, ACNT, and PAA anodes before and after IPL treatment. Before the IPL treatment, a binder PAA peak is present at 1100-1700 cm⁻¹ and the peak is present at 1245 cm⁻¹, a C—O bond of ACNT. Upon the IPL treatment, all PAA peaks were removed and Si-related peaks appeared as shown in FIGS. 10(b), (c), and (d). Large peaks were formed at 2344, 2159 cm⁻¹ related to Si—H bonding, as well as peaks at 965 and 688 cm⁻¹ corresponding to Si—OH bonding and SiO₂, respectively. During the first IPL treatment, a peak at 1245 cm⁻¹, a C—O bond, was still present, confirming that the ACNTs were not fully defunctionalized. However, as the number of the IPL treatments was increased to 2 and 3, the peak at 1245 cm⁻¹ was removed which represents that the ACNTs were all defunctionalized. Similar to the FT-IR results, a proportion of oxygen in the EDX results decreased with an increase in the number of the IPL treatments. Before the IPL treatment, an atomic percentage was 64.1, 28.3, and 7.6% of Si, C, and O, respectively. As the number of the IPL treatments increased from 1 to 3, the atomic percentage of C increased from 28.3 to 48%, and O decreased from 7.6 to 2.12%. An increase in the C ratio indicates that the surface of PAA covering the Si surface is carbonized, and a decrease in the O ratio indicates the carbonization of PAA as well as the defunctionalizing of ACNT.

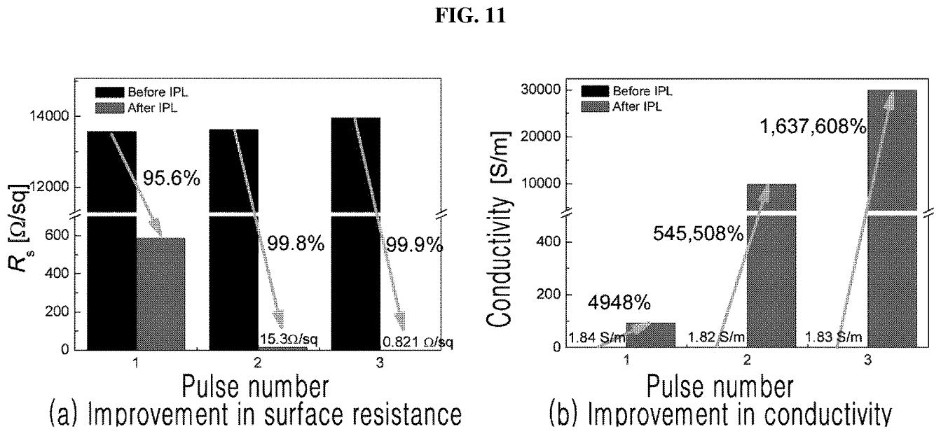

The encapsulation of Si through the IPL treatment, the carbonization of the surface of PAA, and the defunctionalization of ACNT significantly improved the surface electrical properties of an anode. FIGS. 11(a) and (b) show a change in the sheet resistance and conductivity of a Si anode before and after the IPL treatment. The sheet resistance of the Si anode before the IPL treatment was about 13.7 kΩ/sq. As the number of the IPL treatments increased from 1 to 3, the sheet resistance decreased from 586.9 to 0.821 Ω/sq, and a maximum reduction rate of the sheet resistance was 99.99%. Average conductivity before the IPL treatment was 1.83 S/m, and gradually increased to 93.12, 9911.03, and 29974 S/m as the number of the IPL treatments increased. A maximum increase rate was 1,637,608%. The reason for greatly improved electrical properties through the IPL treatment is the formation of structures such as neural networks as well as the surface carbonization of PAA and the defunctionalization of ACNTs. Before the IPL treatment, the sheet resistance is high and the conductivity is very low because nano-sized Si exists between the CNTs and interferes with the CNT connection. However, Si colonies were created through the IPL treatment, which helped the CNTs to connect. In addition, the carbonization of PAA on the surface of Si and the defunctionlization of ACNT promoted improvement in the electrical properties.

Electrochemical impedance spectroscopy (EIS) and a battery test were performed to characterize electrochemical performance of fabricated electrodes. EIS was performed using a Biologic SP-150 Potentiostat under open circuit voltage (OCV) having a potential amplitude of 5 mV over a frequency range from 100 mHz to 200 kHz, at room temperature. All samples went through an EIS test before a charge/discharge test.

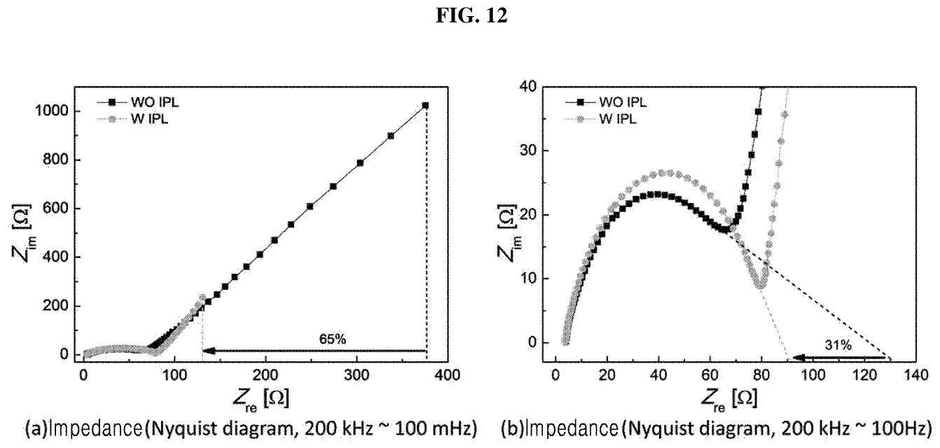

FIGS. 12(a) and 12(b) show results of comparison of the Nyquist plots to ascertain the impedance change of the samples following the IPL treatment. The linear part of FIG. 12(a) shows a lithium-ion diffusion phenomenon in two electrodes, and an impedance spectrum is observed in the linear part. The IPL treatment results in a 65% decrease in the diffusion resistance because of the carbonization and the polymers and the defunctionalization of the ACNTs. A half-circle impedance spectrum in a range of high frequencies is observed in the half circle part of FIG. 12(b), and the half circle part shows movement resistance of charges indicating the oxidation and reduction of lithium ions on an electrode-electrolyte interphase. As a result of the IPL treatment, the size of the half circle is reduced by about 31%, and improvement in the surface electrical conductivity via the IPL treatment is expected to increase a charging speed by reducing the oxidation and reduction speeds of lithium ions.

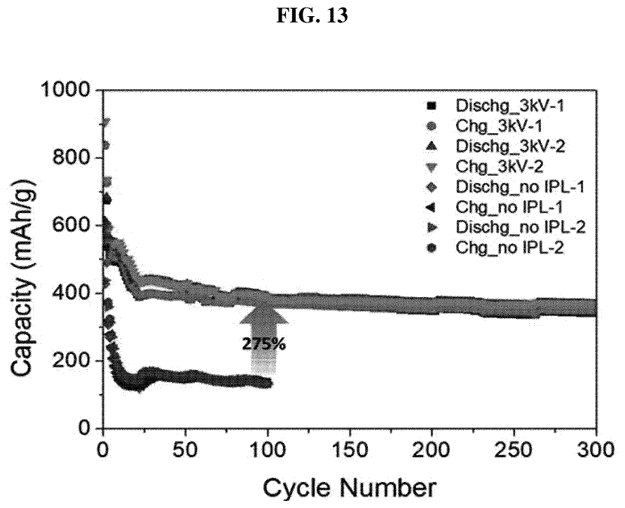

The superior capacity, the nerve-like network Si-CNT anode present good cycling performance at different current densities. The electrodes were tested for different current densities ranging from 0.1 C to 1 C rate for all cases. As shown in FIG. 13, the Si-CNT composites treated with IPL exhibit excellent performance and the restoration of battery capacity. In the first cycle, the capacity of the Si-CNT composites treated with IPL multiple times at 0.1 C rate is 25% to 50% higher than the capacity of the Si-CNT composites not treated with IPL. As the C-rate increases from 0.1 to 0.5 C, the Si-CNT composites were all reduced. The stability of the Si-CNT composites treated with IPL was ascertained at a 1 C-rate through 20 cycle tests. The Si-CNT composites not treated with IPL had capacity reduced by 59% after 20 cycles. However, the Si-CNT composites treated with IPL multiple times had capacity that decreased by 29-33% than the capacity of an initial time point in 20 cycles. This is because the carbonization of Si surface via the IPL treatment suppressed the expansion of Si that is generated during charging and discharging. In relation to the stability, the capacity of Si-CNT composites treated with IPL multiple times was 200% to 256% greater than the capacity of Si-CNT composites not treated with IPL, in 20 cycles.

### 2.2.3 Electro-Spun Mat

A horizontal electro-spinning setup is used for electro-spinning processes. An electro-spinning apparatus uses a high voltage power supply (Gamma High Voltage Research) which is connected to the needles of the syringes mounted on a syringe pump (New Era 4000). The chassis of the pump and a rotating drum were grounded. The drum was rotating at approximately 200 rpm. The chassis was connected to a 100 MΩ resistor to maximize a coating on the drum and minimize a fiber coating elsewhere. A flow rate into the system was set to 0.5 mL/hr to maintain a single droplet at the tips of the needles. The syringe pump was mounted on a XY stage programmed for an oscillating motion to coat fibers uniformly across the entire drum. Electro-spinning is a cost-effective and facile alternative that can be used to produce nano-scale fibers and non-woven mats. Electro-spinning enables porosity and a surface area to be controllable.

Once a mixture of polymers, a solvent, carbon-based additives and active materials is electro-spun, IPL or microwaves can be utilized to partially carbonize as well as generating pores on electro-spun fibers as illustrated in FIG. 6. The porosity within the spun fibers would enhance ion exchange, and lithium-ions can freely enter the fibers to be stored within silicon particles, which are also encapsulated within the fibers. Because of mechanical strength of the fiber structure, the expansion of silicon during a lithiation cycle is suppressed.

### 2.2.4 Pre-Lithiation

In lithium-ion batteries, the first charging process is crucial to a battery's performance During the first charging process, organic electrolytes may be reduced to form a solid electrolyte interphase on an anode surface, or some lithium ions may be trapped in an electrode during the first lithiation process. These may lead to an irreversible loss of net energy capacity in a battery. The first cycle is especially more important if silicon is used for an anode, as the first-cycle Columbic efficiency of silicon anode is in a range of 50 to 80% [Wu et al. 2012; Wu et al. 2013; Yi et al. 2013], relatively lower than that of graphite anode (>80%) [Cui et al. 2009].

One method to compensate a loss of energy density in the first charging cycle is to use a pre-lithiation technique. Pre-lithiation is a technique to add lithium ions to the battery before the first charging cycle, aimed to compensate an irreversible loss of lithium in the first charging cycle and also to provide an additional reservoir of lithium ions due to cell aging.

Research have already been performed into several different methods of pre-lithiation already studied, falling into four different categories. The first is to use lithiated active materials to manufacture an electrode slurry. The second is about an electrochemical method in which a lithium half-cell is formed with external shorting to induce a lithiation process. The third is to chemically reduce active materials using lithium organic complexes, and the last is to directly contact lithium foil or lithium powder to reduce active materials in the presence of a potential difference between a target anode and a lithium source.

The aforementioned pre-lithiation processes have their own pros and cons in each category. Lithium additives used for pre-lithiation have challenges in high chemical reactivity and incompatibility with common binders and solvents. It is difficult to scale up electrochemical pre-lithiation from laboratory experiments, due to its requirement for an assembled battery setup. Chemical pre-lithiation produces chemical wastes, which may include an additional washing process to remove by-products. The direct contact pre-lithiation has its challenge in handling highly reactive lithium metal. Among these techniques, the direct contact pre-lithiation method is considered as a scalable industrial process because of its simplicity. In an effort to alleviate difficulties in highly reactive lithium metal, the use of stabilized lithium metal powder (SLMP) is considered. In this embodiment, the process of pre-lithiation using one of the aforementioned methods is implemented into an anode fabrication process.

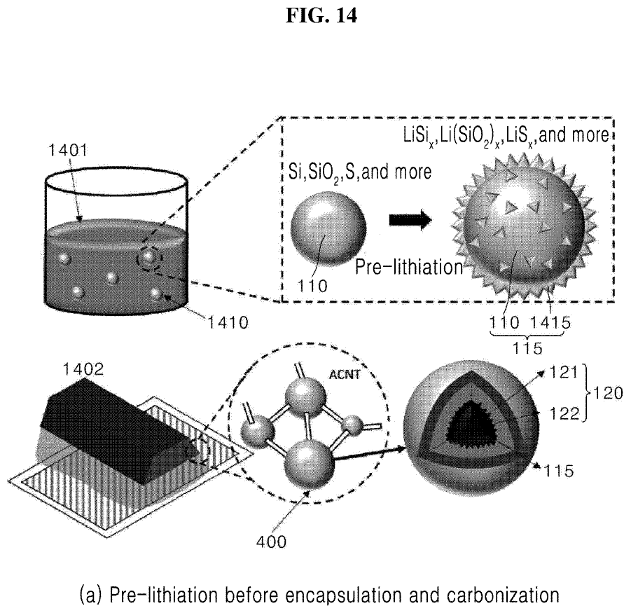

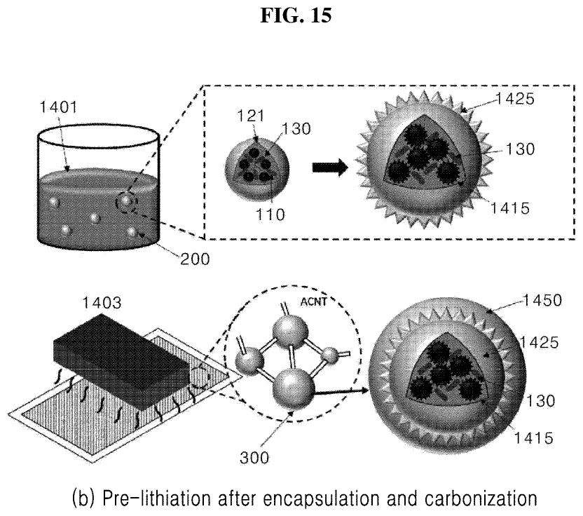

FIGS. 14 and 15 show pre-lithiations, specifically, a pre-lithiation method (FIG. 14) before encapsulation and carbonization, and a pre-lithiation method (FIG. 15) and a manufacturing process after encapsulation and carbonization.

In this disclosure, three methods and manufacturing processes of a pre-lthiated anode are presented. The first is to pre-lithiate active materials before encapsulation and carbonization, as shown in FIG. 14. The pre-lithiation of active materials 110 such as Si or S with a pre-lithiation solution 1401 or lithium powder leads to the production of a lithiated compound 1415 such as LiₓS, LiₓSi or LixSiO on the surfaces of the active materials 110. As a result, pre-lithiated active materials 115 are produced. The pre-lithiated active materials 115 are encapsulated by polymeric bonders 120. When an anode electrode is processed with an energy application method using an apparatus such as an IPL system 1402, the surfaces of the pre-lithiated active materials 400 encapsulated turn into a polymeric inner shell 122 and a carbonized outer shell 121. Although the active materials have already expanded during the pre-lithiation process, the encapsulation of the pre-lithiated active materials is required because those materials mainly react with Li to cause expansion during charging and discharging.

The second is to pre-lithiate active materials after encapsulation and carbonization as shown in FIG. 15. When active materials 200 encapsulated and carbonized are pre-lithiated using a pre-lithiation solution 1401 or lithium powder, the active materials as well as the carbonized surface are lithiated while lithium-ion passes through the porous surface of the active materials. That is, the lithiation of the active materials 110 results in the production of pre-lithiated active materials 1415, the pre-lithiated active materials are encapsulated by polymeric binders including carbonized polymers 121, and the surfaces of the carbonized polymers 121 are also pre-lithiated 1425. Then the pre-lithiated active materials 300, encapsulated and carbonized, are applied to the electrode along with additional polymeric binders 1450 in a slurry form, and dried by a drying system 1403.

The third is to pre-lithiate an electrode after electrode manufacturing and carbonization processes, which is a method of pre-lithiation before cell assembly.

In the above-described method of manufacturing a electrode for a lithium secondary battery according to the disclosure, the encapsulation and active materials, and the carbonization of the same via the application of energy results in a minimization of the volume change of electrodes or its negative side effects, such as high internal stress, a fracture, pulverization, delamination, electronic isolation from a conductive agent, the formation of an unstable solid-electrolyte interphase, and a loss of energy capacity of a battery.

Accordingly, the method of manufacturing an electrode for a lithium secondary battery according to the disclosure can be applied to the manufacturing of batteries such as a lithium-ion battery, a lithium-metal battery, a lithium-air battery, a lithium-sulfur battery, a lithium solid-state battery and the like.

The embodiments are described above with reference to a number of illustrative embodiments thereof. However, numerous other modifications and embodiments can be devised by one skilled in the art. Thus, it is understood that the modifications and changes are included in the scope of the technical spirit of the disclosure as the modification and changes are within the scope of the disclosure.

1. A method of manufacturing an electrode for a lithium secondary battery, comprising:
mixing active materials, polymeric binders, carbon-based additives and a solvent;
encapsulating the active materials by the polymeric binders; and
carbonizing part of the polymeric binders and generating nanopores in the polymeric binders via energy application to the polymeric binders.

2. The method of claim 1, wherein an outer hard shell and an inner soft shell are formed from the polymeric binder via the carbonization.

3. The method of claim 1, wherein the active materials comprise one or more of silicon, silicon oxide, silicon carbide, magnesium silicide, a silicon-iron-manganese alloy, manganese silicate, a silicon alloy, aluminum, tin, LiₓSi—Li₂O core-shell nanoparticles, or sulfur.

4. The method of claim 1, wherein the polymeric binder comprises a first polymer having a low boiling point, and a second or third polymer having a boiling point higher than that of the first polymer, wherein the polymeric binder include two or more of polyacrylonitrile (PAN), polytetrafluoroethylene (PTFE), poly(methyl methacrylate; PMMA), poly(3,4-ethylenedioxythiophene) polystyrene sulfonate (PEDOT:PSS), polydiacetylenes (PDA), polypropylene (PP), polystyrene (PS), polyurethane (PU), polyethylene oxide (PEO), polyethylene terephthalate (PET), Styrene-ethylene-butylene-styrene (SEBS), glycerol, asphaltene, meso-phase pitch, sucrose, cellulose, and lignin.

5. The method of claim 4, wherein the first polymer evaporates via the energy application, and nanopores are formed via the evaporation.

6. The method of claim 1, wherein the polymeric binder comprises double network hydrogels.

7. The method of claim 6, wherein the double network hydrogels are selected from carboxylmethyl cellulose (CMC), polyvinyl alcohol (PVA), and polyacrylic acid (PAA), polyacrylic acid (PAA) and polyethylene glycol (PEG), polyacrylic acid (PAA) and polyethylenimine (PEI), polyacrylic acid (PAA) and chitosan, a styrene/butadiene copolymer (SBR), polymethyl methacrylate (PMMA) and a combination thereof.

8. The method of claim 1, wherein the polymeric binders comprise polymers with elements of active materials.

9. The method of claim 8, wherein the polymers with elements of active materials comprise organosilicon selected from polysiloxane, polysilsesquioxane, polycarbosiloxane, polyborosiloxane and polysilicarbodiimide and sulfur-containing polymers selected from polysulfoxide and poly (sulfur nitride), and
some of the polymers with elements of active materials are converted into one or more of SiOC (silicon oxycarbide), SiC (silicon carbide), SiBCN (silicoboron carbonitride), SiCN (silicon carbonitride), SC (sulfur-carbon composite), or SCN (thiocyanate) via energy application.

10. The method of claim 1, wherein the polymeric binders can comprise piezoelectric polymers.

11. The method of claim 10, wherein the piezoelectric polymers comprise one or more of polyvinylidene fluoride (PVDF), polyvinylidene fluoride trifluoroethylene (PVDF-TRFE), and parylene-C.

12. The method of claim 1, wherein the carbon-based additives comprise one or more of single-walled carbon nanotubes (SWCNTs), multi-walled carbon nanotubes (MWCNTs), thin-walled carbon nanotubes (TWCNTs), carbon fibers, graphene, graphene oxides, and carbon dots.

13. The method of claim 1, wherein the solvent comprises water, N-methyl-2-pyrrolidone (NMP), dimethylformamide (DMF), dimethyl sulfoxide (DMSO), or a combination thereof.

14. The method of claim 1, wherein the encapsulation of active materials comprises preparing a slurry mixture comprising active materials, polymeric binders, carbon-based additives and solvents,
generating droplets via nebulisation, and
drying the droplets in an air-suspended chamber by using a heater while circulating the droplets in air.

15. The method of claim 1, wherein the energy application is performed in a power state, in an electro-spun fiber state or in a state of being applied to an electrode collector.

16. The method of claim 1, wherein in the energy application, one or more of intense pulsed light, a laser, microwaves and Joule's heat are used.

17. The method of claim 1, wherein a carbon precursor material selected from pitch, mesophase pitch, isotropic pitch, and asphaltene is additionally mixed to form a composite of carbon and silicon, silicon oxide or silicon carbide.

18. The method of claim 1, further comprising, one or more pre-lithiation procedures selected from the following steps:
a. pre-lithiating active materials in a powder form before encapsulation and carbonization processes;
b. pre-lithiaiting active materials in a powder form after encapsulation and carbonization processes;
c. pre-lithiating electrodes after electrode manufacturing and carbonization processes;
d. pre-lithiating electrodes by direct contact with lithium metal on the electrodes; and
e. pre-lithiating active materials in a powder form through reduction of lithium by applying energy treatment to lithium salts.

19. A method of manufacturing electrode materials for a secondary battery, comprising:
encapsulating active materials by polymeric binders; and
applying intense pulsed light (IPL) energy to the polymeric binders such that an outer surface of the polymeric binders is carbonized, and an inner surface layers of the polymeric binders are partially carbonized or non-carbonized.

20. A method of manufacturing electrode materials for a secondary battery, comprising:
preparing a slurry mixture containing active materials, polymer binders, carbon-based additives and solvents;
generating droplets from the slurry mixture through a spraying process;
drying the droplet using a heater to form a dry powder; and
applying IPL to the dry powder while floating the dry powder using a blower in a chamber surrounded by a reflector.
